(19) United States
(12) Patent Application Publication
(10) Pub. No.: US 2025/0053913 A1
(43) Pub. Date: Feb. 13, 2025

(54) METHODS AND SYSTEMS FOR TRACKING WORKER BENEFACTION AT AN ORGANIZATION

(71) Applicant: UKG Inc., Weston, FL (US)

(72) Inventors: Cecile Therese Leroux, Weston, FL (US); Christa Degnan Manning, Scituate, MA (US); Ryan Nye Alexander, Weston, FL (US); Brian Robert Muras, Maple Grove, MN (US); Keith Alan Briggs, Pompano Beach, FL (US)

(21) Appl. No.: 18/448,797

(22) Filed: Aug. 11, 2023

(51) Int. Cl. G06Q 10/0639; G06Q 50/00

(52) U.S. Cl. CPC G06Q 10/06398; G06Q 50/01

(57) ABSTRACT

A request for one or more digital badges associated with a particular worker of an organization is received. A team of the organization associated with the particular worker during a tenure of the particular worker at the organization is determined. One or more entries of a digital badge database that are associated with the team are identified. The entries indicate one or more digital badges issued to the team based on a benefaction level determined for workers of the team. A set of digital badges issued to the team during a time period that corresponds to the tenure of the particular worker is extracted from the one or more entries. An indication of the extracted set of digital badges is provided in response to the request.

### TECHNICAL FIELD

Embodiments of the present disclosure relate to computing systems, and more specifically, relate to methods and systems for tracking worker benefaction at an organization.

### BACKGROUND

Workers (e.g., employees, independent contractors, etc.) can perform a wide variety of actions or activities that impact an organization of which they are a part of. For instance, actions or activities of a worker can impact a financial state of an organization, a reputation of the organization, a morale of the organization, a social and/or environmental sustainability of the organization, and so forth. Traditional worker performance systems focus on a direct monetary impact that a worker has on an organization without considering other ways that the worker's activities or actions impact the organization.

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates a high-level component diagram of an example architecture, in accordance with one or more embodiments of the present disclosure.

FIG. 2 is a flow diagram illustrating an example method for tracking worker benefaction at an organization, in accordance with embodiments of the present disclosure.

FIG. 3 illustrates an example worker data engine and an example benefaction engine, in accordance with one or more embodiments of the present disclosure.

FIG. 4 illustrates an example predictive system, in accordance with one or more embodiments of the present disclosure.

FIG. 5 is a flow diagram illustrating an example method for training a machine learning model, in accordance with one or more embodiments of the present disclosure.

FIG. 6 illustrates an example digital badge engine, in accordance with one or more embodiments of the present disclosure.

FIG. 7 depicts an example distributed ledger, in accordance with one or more embodiments of the present disclosure.

FIG. 8 depicts an example graphical user interface (GUI), in accordance with one or more embodiments of the present disclosure.

FIG. 9 is a flow diagram illustrating an example method for determining a digital badge associated with a worker based on digital badges issued to a team of an organization, in accordance with one or more embodiments of the present disclosure.

FIG. 10 is a block diagram illustrating a computing system in which implementations of the disclosure can be used.

### DETAILED DESCRIPTION

Described herein are methods and systems for tracking worker benefaction at an organization. Actions or activities of workers (e.g., employees, independent contractors, etc.) can impact an organization of which they are a part of. For instance, a number of hours that an employee works during a particular time period and/or a number of hours that the employee interacts with a customer or client can impact a financial state of the organization. In another instance, a number of flights taken by the employee to meet with a customer or client (e.g., in person) and/or a number of meetings taken with the customer or client via a video or audio conference call can impact an environmental footprint of the organization. In yet another instance, a number of workers that participate in mentorship programs and/or social activities with other workers can impact an overall morale of the organization.

Organizations can employ multiple systems that enable workers to perform functions of their role at the organization, engage with supervisors and/or other workers of the organization, and/or perform other actions or activities with respect to or on behalf of the organization. For example, in addition to employing a system that enables a worker to perform a function of their role at the organization, the organization can employ a time card system that enables the worker to provide a number of hours worked for the organization, an electronic communication system (e.g., an electronic mail system, an electronic messaging system, etc.), that enables the worker to communicate with other workers of the organization and/or those outside of the organization, a mentorship system that enables workers to volunteer to be a mentor to other workers of the organization and/or schedule a meeting with a mentor or mentee, a social media system that enables a worker to post about the organization on a feed of a social media profile associated with the worker, and so forth.

Each system employed by an organization can collect and/or store data based on worker interaction with the respective system. According to the previous example, a system that enables a worker to perform a function of their role at the organization can provide the worker with access to a word processing application, a spreadsheet application, etc. (e.g., via a client device associated with the worker). The word processing application, for example, can provide the worker with access to an electronic document that is useful to the organization with respect to the worker's job function. The system can store data of the electronic document (e.g., as provided or updated by the worker) in a memory of the system. The system can also store metadata for the electronic document in the memory, the metadata indicating an identifier associated with the worker that updated the electronic document, a timestamp indicating a time period that the worker accessed and/or updated the document, etc. In another example, a mentorship system that enables workers to volunteer to be a mentor to other workers of the organization can store data (e.g., at a memory of the system) indicating a mentorship pairing between two or more workers, a time and date of one or more meetings scheduled between the two or more workers, expenses incurred by the two or more workers during a scheduled meeting, etc. In yet another example, a social media system that enables a worker to post about the organization on a feed of the social media profile associated with the worker can store data (e.g., at a memory of the system) that indicates a content of the post by worker, a timestamp of the date and/or time of the post by the worker, a reception (e.g., a number of impressments, a number of endorsements or “likes,” etc.) of the post by the worker, and so forth.

Some organizations can employ a worker performance system that enables leaders (e.g., managers, supervisors, etc.) of an organization to collect and/or provide data associated with a performance of a worker of the organization. The performance system can provide recommendations and/or insights to the leaders of the organization of whether the worker should be promoted to a more senior role at the organization, a compensation package of the worker should be modified, the worker should be terminated from the organization, and so forth. Traditional worker performance systems provide recommendations and/or insights on performance of workers solely based on a contribution of a worker with respect the worker's function at the organization. For example, traditional worker performance systems provide recommendations and/or insights solely based on a number of hours worked for the organization by the worker for a particular time period. Traditional worker performance systems do not account for contributions by the worker that are distinct from or in addition to the worker's function at the organization. For example, traditional worker performance systems do not access and/or analyze data collected for workers by systems employed by the organization that track contributions that do not relate directly to a worker's job function (e.g., a mentorship system, a social media system, etc.). Accordingly, data collected by such systems may not be used by the organization. Collecting and storing such data by such systems consumes a large amount of computing resources (e.g., processing cycles, memory space, etc.) that is unavailable to other processes of the systems. As a result, fewer resources are available to the other processes, which can decrease an overall efficiency of the systems and/or increase an overall latency of the systems.

Since traditional worker performance systems only consider data collected based on contributions that directly relate to a worker's job function, leaders of the organization may take action with respect to a worker that is not in line with a worker's contribution to the organization. For example, a worker may spend a significant amount of time mentoring or training other workers of the organization (e.g., as indicated by data collected by a mentorship system of the organization), which improves the other worker's ability to perform their job function and/or improves overall morale for the organization. However, traditional worker performance systems may not consider this contribution by the worker when recommending the worker for a promotion to a more senior role or a different compensation package. Accordingly, the worker may become frustrated and resign from the organization, leaving a vacancy in the worker's job function. The organization may employ resources of a recruitment system to recruit and/or hire another worker to fill the vacancy in the worker's job function. The recruitment system can consume a large number of resources (e.g., processing cycles, memory resources) to collect data for each candidate and identify, based on the collected data, a qualified candidate for the vacant role. Such resources are unavailable to other processes of the systems, which can further decrease an overall efficiency and/or increase an overall latency of the systems.

As indicated above, a worker of an organization can perform actions and/or activities that are distinct from and/or in addition to actions or activities associated with the worker's role at the organization. The actions and/or activities can be in line with one or more goals or objectives of the worker and/or the organization. For example, an organization can have a goal of reducing a carbon footprint of the organization by 5% in a time period of ten years. A worker that conducts meetings with clients and/or customers via video or audio conferencing can be associated with a lower carbon footprint than a worker that travels (e.g., via air travel) to a location of the client and/or customer to meet with the client and/or customer (e.g., in person). Accordingly, an activity or action of conducting a meeting via video or audio conferencing by a worker can help the organization to achieve the goal of reducing the carbon footprint of the organization. Actions and/or activities of a worker across the multiple systems employed by an organization can provide an impact of the organization. However, conventional systems do not enable the organization or the workers of the organization to track a contribution of the worker across the multiple systems (e.g., in accordance with goals of the organization and/or workers of the organization). As indicated above, the data collected by such systems may be unused by the organization, which can result in a decrease in the overall efficiency for the systems and/or an increase in the overall latency of the systems.

Implementations of this disclosure address the above-mentioned and other deficiencies by providing techniques for tracking worker benefaction at an organization. In some embodiments, a platform (e.g., a worker management platform) can collect data associated with one or more workers (e.g., employees, independent contractors, etc.) of an organization. The data can be collected from one or more systems employed by the organization, in some embodiments. For example, data can be collected from a time card system, a mentorship system, etc. employed by the organization. In other or similar embodiments, the data can be collected from a system associated with the workers of the organization. For example, data can be collected based on information (e.g., public information) associated with a profile of a worker for a social media platform. The collected data associated with the one or more workers can indicate one or more actions or activities performed by the workers. For example, the collected data can indicate actions or activities of the worker with respect to a mentorship program of which the worker participates, actions performed by the worker via a client device issued to the worker by the organization, activities of the worker with respect to a social media profile of the organization, and so forth.

The platform collects the data associated with the one or more workers and can store the collected data at a memory. In some embodiments, the platform can identify the collected data at the memory and can provide the identified data as input to a machine learning model. The machine learning model can be trained to predict, based on given input data indicating actions or activities of workers, a benefaction level associated with the workers relative to other workers of the organization. Benefaction of a worker refers to a contribution or impact of a worker to a goal or objective of the organization or the worker. A benefaction level refers to or otherwise represents a metric indicating an amount or extent of the contribution or impact of the worker to the goal or the objective. In some embodiments, the benefaction level can be represented as a rating or a score that is normalized based on an aggregate benefaction level determined for all workers (or a subset of all workers) of the organization. In additional or alternative embodiments, the benefaction level can be represented as multiple ratings or scores that each correspond to a respective goal or objective of the organization or a respective worker. In some embodiments, the platform can feed data collected for all workers (or a subset of all workers) as input to the machine learning model. One or more outputs of the machine learning model can indicate a benefaction level of each of the workers of the organization (or the subset of the workers) relative to other workers of the organization. Further details regarding training and inference with respect to the machine learning model are provided herein.

Upon obtaining the one or more outputs of the machine learning model, the platform can extract a benefaction level for each of the workers of the organization (or the subset of workers) from the one or more outputs. In some embodiments, the platform can determine whether a respective benefaction level for a respective worker of the organization satisfies one or more criteria associated with the respective worker and/or the organization. The one or more criteria can include one or more threshold conditions, in some embodiments. The respective benefaction level for the respective worker can satisfy the one or more criteria if the benefaction level meets or exceeds the threshold condition associated with a particular goal or objective of the worker and/or the organization, in some embodiments. In some embodiments, the goal or the objective can be provided to the platform from a client device associated with a user of the platform. The user can include a worker, a manager, a supervisor, an executive, etc. of the organization, in some embodiments. In some embodiments, a representative of the organization (e.g., an executive, a worker that performs functions on behalf of an executive, etc.) can provide an indication of one or more goals or objectives of the organization via a client device. The indication of the one or more goals or objectives can define the one or more criteria associated with each goal or objective and the one or more threshold conditions that are to be met or exceeded in order for the criteria to be satisfied. Further details regarding goals and objectives of the organization and/or the worker and criteria associated with such goals and objectives are provided herein.

The platform can determine whether the respective benefaction level for the respective worker (e.g., determined based on output(s) of the machine learning model) satisfy the one or more criteria associated with the goal and/or objective. In response to determining that the one or more criteria are satisfied, the platform can update a digital badge database associated with the organization to indicate a digital badge issued to the respective worker. The digital badge database can store indications of one or more digital badges issued to workers of the organization in accordance with goals or objectives of the organization and/or the workers, in some embodiments. In some embodiments, the digital badge database can be included with or accessible to a distributed ledger network. A digital badge can indicate that the respective benefaction level for the respective worker satisfies the one or more criteria associated with the goal of the organization and/or the worker. In some embodiments, the platform can maintain one or more profiles associated with each worker of the organization. The profiles may be accessible to leaders, managers, supervisors, other workers, etc. of the organization via a client device connected to the platform (e.g., via a network), in some embodiments. The platform can, responsive to updating the digital badge database associated with the organization, update a profile associated with the respective worker to indicate that the digital badge is issued to the respective worker. The platform can provide the indication of the digital badge via a graphical user interface (GUI) of a client device associated with the respective user and/or other users of the platform (e.g., workers, leaders, managers, supervisors, etc.) when the profile of the respective worker is accessed. In some embodiments, upon updating the digital badge database, the platform can remove (e.g., erase, etc.) the data collected for the worker that is issued the badge from memory.

In an illustrative example, an organization can indicate to the platform a goal or objective to reduce a carbon footprint (e.g., measured by carbon emissions) associated with the organization by 5% over a time period of ten years. The platform can identify data collected from one or more systems based on actions or activities of workers of an organization over a particular time period and feed the identified data as input to the trained machine learning model, as indicated above. An output of the machine learning model can indicate a benefaction level for each worker of the organization, the benefaction level indicating an impact (e.g., a positive impact, a negative impact, a neutral impact, etc.) that each worker has on the carbon footprint of the organization during that time period. The platform can extract the benefaction level for each worker from the output of the machine learning model and can identify one or more workers associated with a benefaction level that meets or exceeds a threshold benefaction level associated with the goal or objective of the organization. The platform can update the digital badge database to indicate that each of the identified one or more workers are issued a digital badge associated with the goal or objective of the organization. The platform can additionally update profiles associated with the identified workers to include an indication of the digital badge and, in some embodiments, remove (e.g., erase) data from the memory associated with the organization.

In some embodiments, a respective worker that is issued a digital badge can provide a request (e.g., via a client device associated with the respective worker) to share the indication of the digital badge with another profile hosted by one or more platforms outside of the organization (e.g., a social media platform, etc.). In accordance with the previous example, a worker that is issued a digital badge associated with a carbon footprint of the organization can request that the digital badge be shared with a social media profile associated with the worker hosted by a social media platform. The platform can provide an indication of the digital badge to the social media platform (e.g., via a network) and the social media platform can update the social media profile associated with the worker to include the indication of the digital badge.

In some embodiments, the platform can be configured to provide recommendations and/or insights associated with actions to be taken with respect to workers of the organization (e.g., in accordance with a worker performance review process of the organization). For example, the platform can provide recommendations and/or insights to a manager or supervisor of a worker as to whether the worker should be promoted or terminated, and/or whether a compensation package and/or a role associated with the worker should be modified. The platform can determine the recommendations and/or insights based on one or more outputs of a machine learning model, based on one or more outputs of a rules-based model, etc., in some embodiments, and can provide the recommendations and/or insights to the manager or supervisor of the worker via a client device associated with the manager or supervisor. In some embodiments, the platform can determine the recommendations and/or insights based on one or more digital badges issued to the worker, in accordance with techniques indicated herein. In an illustrative example, the platform can determine the recommendations and/or insights to be provided with respect to the worker by identifying data associated with the worker and providing the identified data as input to a machine learning model. The machine learning model can be trained to predict, based on given input data associated with a worker, whether the worker is to be promoted or terminated, or whether a compensation package associated with the worker is to be modified. The platform can parse the digital badge database and can identify one or more digital badges issued to the worker, in accordance with embodiments described herein. The platform can provide an indication of the identified one or more digital badges with the identified data associated with the worker as input to the machine learning model. The output of the model can be provided, at least in part, based on the indicated digital badges issued to the worker, in some embodiments. Accordingly, the digital badges associated with the worker can impact a recommendation or insight associated with an action to be taken with respect to a worker of the organization, in some embodiments.

In additional or alternative embodiments, the platform can issue badges to teams or groups of workers rather than to individual workers, in accordance with embodiments described herein. A team or group of workers can be defined based on an organizational structure of an organization, in some embodiments. The platform can receive a request for one or more digital badges associated with a particular worker of the organization, in some embodiments. The platform can determine one or more teams or groups of the organization that included the particular worker during a time period of a tenure of the worker at the organization. The platform can parse the digital badge database to identify digital badges issued to the determined one or more teams during the time period of the tenure of the worker and can provide an indication of the identified digital badges in response to the request. In some embodiments, the request can be received from an application that manages a profile associated with the particular worker (e.g., hosted by the organization, a social media platform, etc.). The platform can provide an indication of the identified one or more digital badges in response to the request and, in some embodiments, the profile associated with the particular worker can be updated to include the indication of the one or more digital badges.

Aspects of the present disclosure address the above and other deficiencies by providing techniques for analyzing data collected for workers of an organization to determine a benefaction level for the workers in view of goals or objectives of an organization or the workers. The platform can issue digital badges to workers that satisfy criteria associated with the goals or objectives. The digital badges can be used to indicate a contribution of the worker with respect to a particular goal or objective of the organization. In some embodiments, the digital badges can be used to determine an action to be taken with respect to the worker (e.g., by a manager, a supervisor, or other leader of the organization), as described herein. As indicated above, data collected for the worker by various systems employed by an organization can be removed (e.g., erased) from memory upon determination of the benefaction level for the worker and/or assignment of a digital badge to the worker. Accordingly, more memory resources and processing resources are made available to the systems, which can improve an overall efficiency and decrease an overall latency of the systems. Further, the digital badges can be issued to teams or groups of the organization instead of individual workers of the organization. Digital badges issued to teams or groups can, in some instances, consume a smaller amount of memory in the digital credential database than credentials issued to individual workers. Accordingly, a larger amount of memory resources and processing resources are made available to other processes, which can further improve an overall efficiency and decrease an overall latency of the systems.

As indicated above, the platform can provide recommendations and/or insights to leaders of the organization (e.g., managers, supervisors, etc.) with respect to actions to be taken with respect to workers based on the above described digital credentials. Accordingly, embodiments of the present disclosure provide techniques for enabling managers, supervisors, and/or other leaders of an organization to recognize contributions made by a worker to an organization beyond a job function of the worker. The worker accordingly may feel more satisfied with their experience at the organization and may continue to work at the organization for a longer time period than if the contributions were not recognized. Accordingly, a fewer number of vacant worker roles may be available with the organization, and a fewer number of resources are consumed by recruitment and/or interview systems to fill vacant worker roles. Such resources are therefore available to other processes of the systems, which can further improve an overall efficiency and decrease an overall latency of the systems.

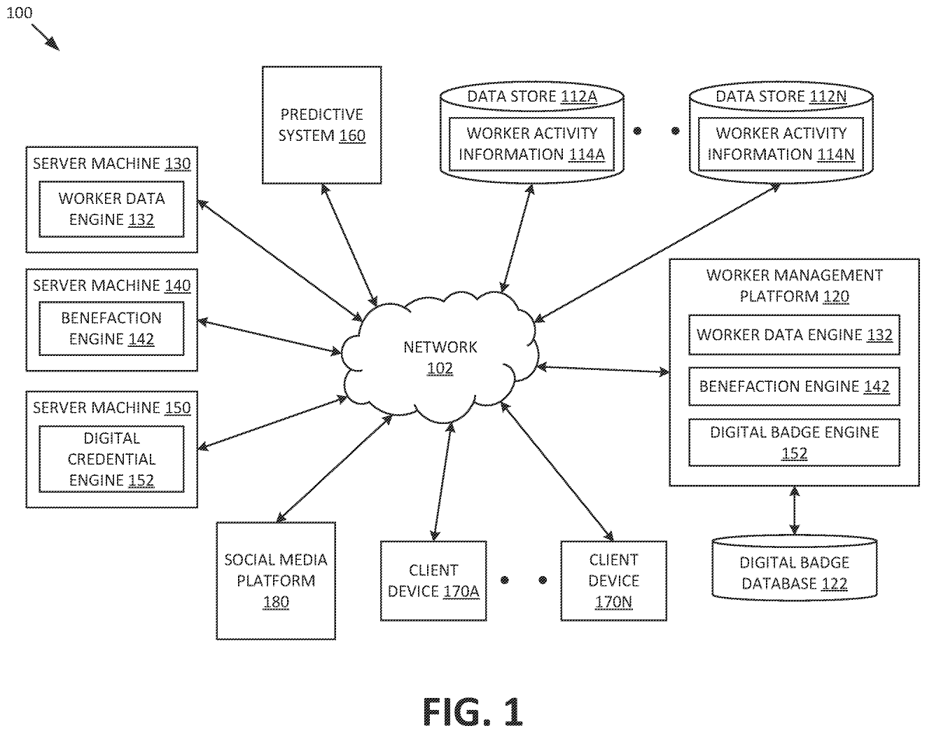

FIG. 1 illustrates a high-level component diagram of an example system architecture 100, in accordance with one or more aspects of the present disclosure. The system architecture 100 (also referred to as “system” herein) includes one or more data stores 112, worker management platform 120, server machine 130, server machine 140, server machine 150 worker, a predictive system 160, a social media platform 180, and/or one or more client devices 170A-N (collectively and individually referred to as client device(s) 170), each connected to a network 102. In some embodiments, network 102 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data stores 112 (collectively and individually referred to as data store 112 herein) include a persistent storage that is capable of storing data as well as data structures to tag, organize, and index the data. Data store 112 may be hosted by one or more storage devices, such as main memory, magnetic or optical storage-based disks, tapes or hard drives, NAS, SAN, and so forth. In some implementations, data store 112 may be a network-attached file server, while in other embodiments data store 112 may be some other type of persistent storage such as an object-oriented database, a relational database, and so forth, that may be hosted by platform 120 or one or more different machines coupled to the platform 120 via network 102.

Client device(s) 170 can include computing devices such as a personal computer (PC), a laptop, a mobile phone, a tablet computer, or any other computing device. In some embodiments, client device(s) 170 may also be referred to as “user devices.” In some embodiments, client device(s) 170 can be associated with an organization. An organization can refer to any entity including one or more people and having a particular purpose. For example, an organization can include a company, an institution, an association, a government, a charity, a partnership, etc. In some embodiments, an organization can include one or more workers. A worker refers to an individual (or group of individuals) that performs specific tasks on behalf of the organization. For example, a worker can include an employee (e.g., a full time employee, a part time employee, etc.), an independent contractor, an official of the organization (e.g., a director, etc.), a volunteer, and so forth. In some embodiments, a worker of an organization can report to other workers of the organization (referred to as “managers” or “supervisors” herein). A manager of an organization can report to other managers of the organization, who can report to other managers, and so on. For purposes of explanation and illustration only, a worker refers to an individual (or group of individuals) of an organization that are supervised one or more other workers (e.g., managers) of the organization. It should be noted that embodiments of the present disclosure can be applied to any type of individual of an organization. In some embodiments, a client device 170 can be associated with a respective worker of an organization. In one example, a first client device 170A can be associated with a worker and a second client device 170B can be associated with a manager of the worker.

Worker management platform 120 (referred to simply as “platform 120” herein) can provide client device(s) 170 with access to one or more applications that enable an organization to manage data associated with the organization. Platform 120 can also collect data associated with one or more workers of the organization and, in some embodiments, can store the collected data at data store 112. As illustrated in FIG. 1, platform 120 can include a worker data engine 132, a benefaction engine 142, and/or a digital badge engine 152, in some embodiments. An engine may refer to hardware (e.g., circuitry, dedicated logic, programmable logic, microcode, processing device, etc.), software (e.g., instructions running on a processing device, a general purpose computer system, or a dedicated machine), firmware, microcode, or a combination thereof. Worker data engine 132 can be configured to manage data (e.g., work data, activity or action data, etc.) associated with workers of the organization, in accordance with embodiments herein. Work data refers to or can include data associated with a worker that pertains to a function or a role of the worker with respect to the organization. Activity or action data refers to or can include data associated with one or more actions or activities of a worker (e.g., with respect to the worker's function or role or separate from the worker's function or role at the organization). In some embodiments, work data and/or activity or action data associated with workers of the organization can be stored at data store 112 as worker activity information 114. As illustrated in FIG. 1, system 100 can include multiple data stores 112 in some embodiments. Each data store 112 can be configured to store worker activity information 114 that is collected by or otherwise associated with one or more systems of the organization. In an illustrative example, data store 112A can be configured to store worker activity information 114A obtained by one or more systems that enable workers to perform their job function (e.g., systems that provide access to word processing applications, document management applications, etc.), data store 112B can be configured to store worker activity information 114B obtained by one or more time card systems employed by the organization, data store 112C can be configured to store worker activity information 114C obtained by a mentorship system employed by the organization, and so forth. It should be noted that in some embodiments, worker activity information 114 collected by or otherwise associated with systems employed by the organization can be stored at a single data store 112 or multiple data stores 112, as described herein.

Benefaction engine 142 can be configured to determine a benefaction level associated with workers of the organization. Benefaction of a worker refers to a contribution or impact of a worker to a goal or objective of the organization or the worker. A benefaction level refers to or otherwise represents a metric indicating an amount or extent of the contribution or impact of the worker to the goal or the objective. In some embodiments, the benefaction level can be represented as a rating or a score that is normalized based on an aggregate benefaction level determined for all workers (or a subset of all workers) of the organization. In additional or alternative embodiments, the benefaction level can be represented as multiple ratings or scores that each correspond to a respective goal or objective of the organization or a respective worker. In some embodiments, benefaction engine 142 can determine a benefaction level associated with workers of the organization based on one or more outputs of a machine learning model. Predictive system 160 can be configured to train a machine learning model (not shown) to predict a benefaction level associated with workers of an organization relative to other workers of the organization. Predictive system 160 can train the model based on historical data associated with one or more activities or actions of workers of the organization. The historical data can include worker activity information 114 at data store 112, in some embodiments. Benefaction engine 142 can obtain worker activity information 114 for one or more workers from data store 112 and can provide the obtained information 114 as input to the trained model, in some embodiments. Benefaction engine 142 can obtain one or more outputs of the model, which can indicate a respective benefaction level for each of the one or more workers relative to other workers of the organization. In some embodiments, benefaction engine 142 can determine the benefaction level associated with a respective worker based on the obtained one or more outputs of the model. Further details regarding worker benefaction, determining a benefaction level for one or more workers of an organization, and predictive system 160 are provided herein.

In some embodiments, platform 120 can additionally or alternatively include a digital badge engine 152. Digital badge engine 152 can be configured to issue one or more digital badges to workers (or teams of workers) based on a benefaction level associated with the workers (or the teams of workers). A digital badge refers to or can otherwise include a digital asset that can indicate whether a benefaction level associated with a worker satisfies one or more criteria associated with a goal or objective associated with the organization. In some embodiments, a goal or objective can be defined by one or more representatives of the organization and/or by a worker of the organization. In some embodiments, platform 120 can provide one or more applications to client device 170 that enables a worker and/or a representative of an organization to provide an indication of one or more goals or objectives and/or one or more criteria that are to be satisfied in order for the goals or objectives to be met. Further details regarding providing the goals or objectives and/or the criteria for the goals or objectives are provided herein.

In one or more embodiments, a leader of the organization (e.g., an executive, a supervisor, a manager, etc.) can provide an indication of a goal or objective of the organization to platform 120 (e.g., via a client device 170). The indicated goal or objective can be associated with one or more criteria that are to be satisfied in order for the goal or objective to be met. In some embodiments, the one or more criteria are to be satisfied by the organization (e.g., as a whole) in order for the goal or objective to be met. For example, the goal or objective can relate to a reduction in carbon emissions by the organization, and the criteria can correspond to a particular reduction in the carbon footprint of the organization within a particular time period. The goal or objective can be met by the organization if workers, systems, assets, etc. contribute to the reduction in the carbon footprint of the organization within the particular time period. Such goal or objective can be tied to the collective action or activity of the organization, rather than the action or activity or an individual worker, system, asset, etc. In other or similar embodiments, the one or more criteria associated with the goal or objective are to be satisfied by particular workers (or groups of workers) of the organization. For example, the goal or objective can relate to an increase in customer awareness of a particular initiative of the organization. A function or role of a marketing team at the organization can be to engage with customers of the organization and provide customers with information about initiatives of the organization. Accordingly, the criteria associated with the goal or objective are to be satisfied by the marketing team (or other such related team) of the organization.

As indicated above, in some embodiments, a goal or objective can be defined by a particular worker of an organization, rather than by a representative or leader of the organization. In an illustrative example, a worker of an organization may value environmental sustainability. The worker can provide an indication to the platform of a goal or objective by the worker to reduce a personal carbon footprint of the worker. The goal or objective of the worker can indicate one or more criteria that the worker is to satisfy in order for the goal to be met. Such goal or objective and corresponding criteria can be associated with the particular worker (or a team or group to which the particular worker belongs) instead of the organization as a whole.

In other or similar embodiments, a goal or objective can be recommended by one or more components (e.g., predictive system 160) of system 100. In an illustrative example, a component of system 100 (or outside of system 100) can provide information associated with workers of the organization as input to a machine learning model that is trained to recommend a goal or objective for a particular worker (or group of workers) and/or the organization based on given activity data for workers of the organization. The machine learning model may be trained on historical activity data associated with prior activities of workers at or outside of the organization, as described herein. The component can obtain one or more outputs of the machine learning model, the one or more outputs indicating a goal or objective that corresponds to the activity of the workers (e.g., as indicated by the given activity data). In some embodiments, the one or more outputs of the model can additionally or alternatively include an indication of one or more criteria that are to be satisfied by a particular worker and/or the organization in order for the goal or objective to be achieved. In another illustrative example, the component can provide an indication of a goal set by a representative or leader of the organization as additional input to the machine learning model. The machine learning model can be further trained to predict an updated goal or objective for a worker and/or an organization based on a given goal or objective provided by a leader or representative of the organization and activity data of one or more workers (e.g., within the organization or outside of the organization). The component can extract the updated goal or objective from one or more outputs of the machine learning model, in some embodiments. In some embodiments, the component can provide an indication of a goal or objective obtained from one or more outputs of a machine learning model to a client device 170 associated with a leader or representative of the organization. The leader or representative can provide an indication of whether the obtained goal or objective is approved (e.g., via a UI of the client device 170). In other or similar embodiments, the system can recognize the goal or objective as a goal or objective for a worker and/or the organization without input from a leader or representative of the organization. In additional or alternative embodiments, the component can perform a natural language processing (NLP) analysis to compare a goal or objective obtained from one or more outputs of a machine learning model can be compared to known benefactions, charities, noble causes, or other such sentiments, to determine whether the goal or objective should be associated with a worker or the organization.

As indicated above, digital badge engine 152 can be configured to issue one or more digital badges to workers (or teams of workers) based on a benefaction level determined for the workers (or teams of workers). In some embodiments, digital badge engine 152 can obtain benefaction data associated with one or more workers of the organization. The benefaction data can indicate a benefaction level determined for the one or more workers, in some embodiments. Benefaction engine 142 can provide the benefaction data to digital badge engine 152 (e.g., via network 102, via a bus, etc.). Digital badge engine 152 can determine whether the benefaction level for a respective worker satisfies one or more criteria associated with a goal defined by the respective worker and/or the organization, in some embodiments. If the benefaction level satisfies the one or more criteria, digital badge engine 152 can issue a digital badge to the respective worker (or a team that includes the respective worker) and can update a digital badge database 122 to include an indication of the digital badge issued to the worker (or the team). In some embodiments, the digital badge database 122 can be managed or otherwise associated with the organization. In other or similar embodiments, the digital badge database 122 can be managed or otherwise associated with another organization or entity (e.g., an entity that provides a social media platform, etc.). Digital badge database 122 can include any type of database that is configured to store data. In some embodiments, digital badge database 122 can include or can otherwise correspond to a distributed ledger network (e.g., a blockchain network), as described herein.

In some embodiments, worker management platform 120 can provide client device(s) with access to an application that enables a worker and/or a manager to access information associated with the worker. For example, the application can generate or otherwise maintain a worker profile associated with each worker of the organization. Each worker profile can include information associated with the respective worker. The worker and/or the manager can access the worker profile via client device(s) 170, in some embodiments. In some embodiments, worker management platform 120 can update a profile associated with a respective worker to include an indication of one or more digital badges issued to the worker, as described above. The indication of the digital badge(s) can be included in the worker profile that is accessible to the worker and/or the manager, in some embodiments. The indication can include data of the digital badge issued to the worker or, in some embodiments, a mapping to an entry of digital badge database 122 that includes the data of the digital badge. Further details regarding worker profiles and digital badges issued to workers are described herein.

As illustrated in FIG. 1, system 100 can include a social media platform 180. Social media platform 180 can enable users to share ideas, thoughts, or information via one or more client devices (e.g., client device(s) 170, etc.) connected to the social media platform 180. In some embodiments, social media platform 180 can be associated with or distinct from the organization that manages platform 120. Social media platform 180 can maintain or otherwise host a social media profile associated with each user of the social media platform 180. In some embodiments, one or more users of social media platform 180 can be workers of the organization, as described herein. Accordingly, social media platform 180 can maintain or otherwise host a social media profile associated with one or more workers of the organization, in some embodiments.

In some embodiments, social media platform 180 can transmit a request to worker management platform 120 and/or digital badge database 122 for information associated with one or more digital badges issued to a worker of the organization. The request can be transmitted to worker management platform 120 and/or digital badge database 122 via an application programming interface (API) between the worker management platform 120 and/or the digital badge database 122, in some embodiments. In response to receiving the request, worker management platform 120 and/or a processing device associated with digital badge database 122 can identify one or more entries of digital badge database 122 that correspond to the worker and can determine one or more digital badges issued to the worker based on the identified one or more entries. In some embodiments, worker management platform 120 can provide an indication of the one or more digital badges to social media platform 180 (e.g., via network 102). Social media platform 180 can update one or more social media profiles associated with the worker to include an indication of the digital badges, in some embodiments. Further details regarding the social media platform 180 are provided herein.

It should be noted that although FIG. 1 illustrates worker data engine 132, benefaction engine 142, and digital badge engine 152 as part of platform 120, in additional or alternative embodiments, worker data engine 132, benefaction engine 142, and/or digital badge engine 152 can reside on one or more server machines that are remote from platform 120 (e.g., server machine 130, server machine 140, and/or server machine 150). In an illustrative example, worker data engine 132 can reside at server machine 130, benefaction engine 142 can reside at server machine 140, and digital credential engine 152 can reside at server machine 150, in some embodiments. It should be noted that in some other implementations, the functions of server machines 130, 140, 150 and/or platform 120 can be provided by a fewer number of machines. For example, in some implementations, components and/or modules of any of server machines 130, 140, 150 may be integrated into a single machine, while in other implementations components and/or modules of any of server machines 130, 140, 150 may be integrated into multiple machines. In addition, in some implementations, components and/or modules of any of server machines 130, 140, 150 may be integrated into platform 120.

In general, functions described in implementations as being performed by platform 120 and/or any of server machines 130, 140, 150 can also be performed on the client devices 170A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.”

In situations in which the systems discussed here collect personal information about users or worker, or can make use of personal information, the users or workers can be provided with an opportunity to control whether platform 120 and/or platform 180 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120 and/or platform 180.

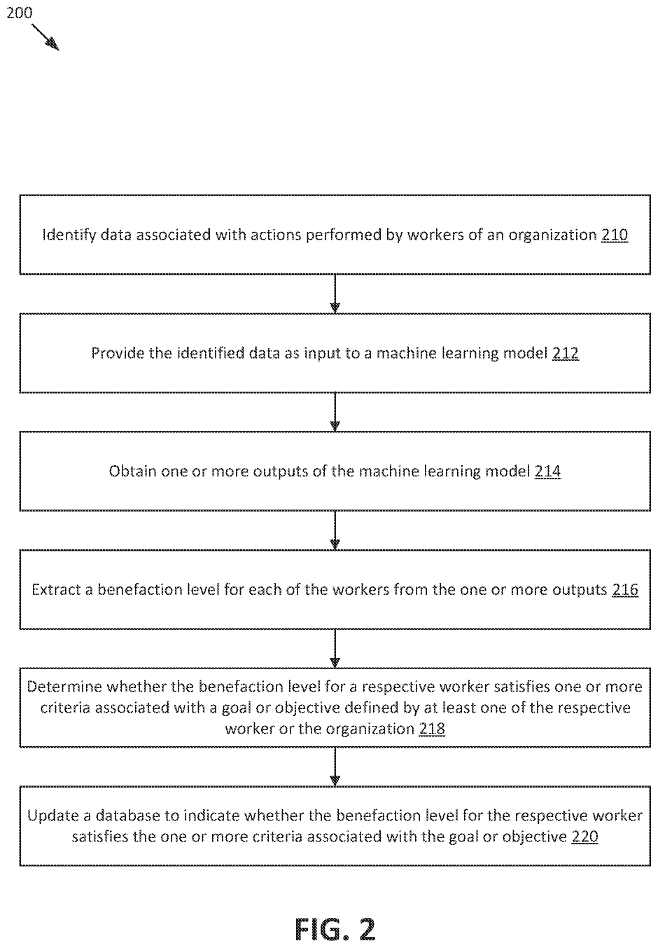

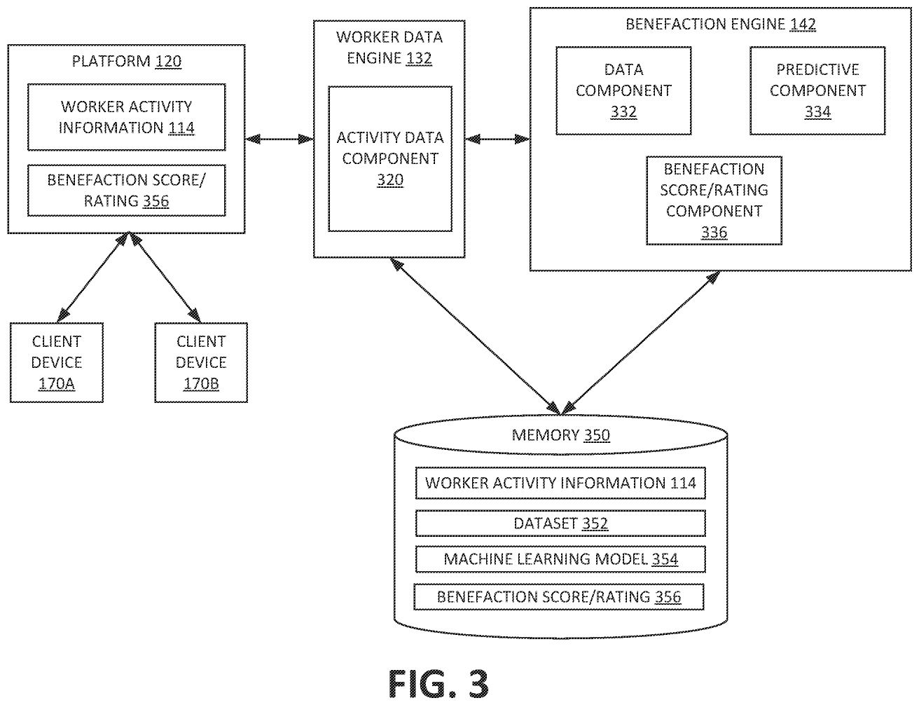

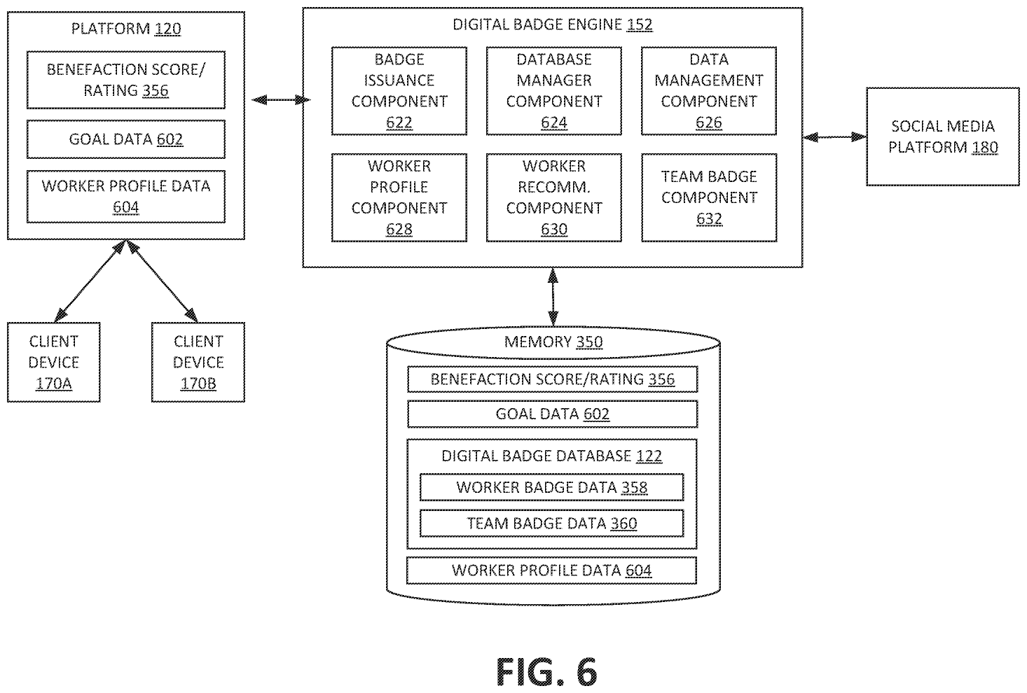

FIG. 2 is a flow diagram illustrating an example method 200 for tracking worker benefaction at an organization, in accordance with embodiments of the present disclosure. Method 200 can be performed by processing logic that can include hardware (circuitry, dedicated logic, etc.), software (e.g., instructions run on a processing device), or a combination thereof. In one implementation, some or all of the operations of method 200 can be performed by one or more components of system 100 of FIG. 1. In some embodiments, some or all of the operations of method 200 can be performed by worker management platform 120, as described above. For example, some or all of the operations of method 200 can be performed by worker data engine 132 and benefaction engine 142 of FIG. 1 and FIG. 3 and/or digital badge engine 152 of FIG. 1 and FIG. 6, in some embodiments.

At block 210, processing logic identifies data associated with actions performed by workers of an organization. The data can be identified from one or more data sources associated with at least one of the workers or the organization, in some embodiments. In some embodiments, the data can be identified by worker data engine 132 of FIG. 3. FIG. 3 depicts an example worker data engine 132 and an example benefaction engine 142, in accordance with embodiments of the present disclosure. As described above, worker data engine 132 and/or benefaction engine 142 can be included with or otherwise accessible to worker management platform 120, in some embodiments. As illustrated in FIG. 3, worker data engine 132 and/or benefaction engine 142 can be connected to a memory 350. Memory 350 can correspond to or otherwise include data store 112 and/or digital badge database 122 of FIG. 1. It should be noted that memory 350 can correspond to or otherwise include any memory of system 100 and/or any memory accessible to components of system 100.

As described with respect to FIG. 1, data store(s) 112 can be configured to store worker activity information 114 associated with one or more workers of an organization. Worker activity information 114 can include data collected or otherwise obtained by one or more systems employed by the organization, as described above. In some embodiments, worker activity information 114 can additionally or alternatively include data collected or otherwise obtained by one or more other systems or platforms (e.g., that are not employed by the organization). For example, worker activity information 114 can obtained based on a social media platform (e.g., social media platform 180) that maintains a profile associated with one or more workers of the organization. In another example, worker activity information 114 can be obtained based on information associated with a worker that is available via a website, a blog, etc. associated with another organization (e.g., a news-based organization, a charity-based organization, etc.). In some embodiments, worker data engine 132 (and/or another component of system 100) can employ a natural language processing (NLP) engine that parse various sources (e.g., news sources, etc.) for information associated with one or more workers of the organization. In an illustrative example, worker data engine 132 can receive a notification (e.g., from a content-alert service, etc.) that one or more workers of the organization are mentioned in an article published on a website associated with a news-based organization. Worker data engine 132 can provide the article, or an indication of the article, to the NLP engine. The NLP engine can parse the article and can extract information from the article associated with the one or more workers. The extracted information can be stored at memory 350 as worker activity information 114, as described herein. It should be noted that worker data engine 132 can obtain information associated workers of the organization from sources outside of the organization according to other techniques. Worker activity information 114 can additionally or alternatively include data that is provided to platform 120 by workers of the organization. For example, a worker of an organization can provide information associated with one or more actions or activities performed by the worker via a client device 170 associated with the worker, in some embodiments.

Worker data engine 132 and/or platform 120 can access worker activity information 114 at data store(s) 112 via a network (e.g., network 102), in some embodiments. In some embodiments, worker data engine 132 and/or platform 120 can access the worker activity information 114 in response to detecting that the worker activity information 114 has been added to, removed from, or modified at one or more of data store(s) 112. In other or similar embodiments, worker data engine 132 and/or platform 120 can periodically access data store(s) 112 (e.g., according to a pre-determined or pre-defined access schedule) to identify worker activity information 114. In some embodiments, worker data engine 132 and/or platform 120 can identify worker activity information 114 associated with all workers of the organization, a subset of workers of the organization, or a particular worker of the organization.

As illustrated in FIG. 3, worker data engine 132 can include an activity data component 320. In some embodiments, activity data component 320 can parse worker activity information 114 and can organize worker activity information 114 into one or more datasets 352. Activity data module 320 can store the datasets 352 at memory 350, in some embodiments. Each dataset 352 can include particular data of worker activity information 114 based on an organization scheme employed by activity data component 320. For example, each dataset 352 can include activity data associated with a respective worker of the organization. In another example, each dataset 352 can include data associated with a respective activity (or category of activities) performed by one or more workers of the organization. As indicated above, worker activity information 114 can be collected by or otherwise associated with multiple systems employed by an organization. In some embodiments, each dataset 352 organized or otherwise created by activity data component 320 can include information collected by multiple systems that are associated with a common worker and/or a common activity or action, in some embodiments. For example, a dataset 352 can include data or information associated with actions or activities performed by a particular worker and is collected or obtained by multiple systems employed by the organization. In another example, a dataset 352 can include data or information associated with a particular action or activity performed by one or more workers and collected or obtained by multiple systems employed by the organization.

In some embodiments, activity data component 320 can determine that information of an action or activity is associated with a particular worker of the organization based on data or metadata associated with the information. For example, worker activity information 114 can include data associated with a meeting conducted with one or more customers of the organization using a video conferencing platform. Such worker activity information 114 can include an indication of one or more workers of the organization that were invited to, attended, and/or participated in the meeting. The worker activity information 114 can additionally or alternatively include an indication of one or more workers that were invited to the meeting, but did not attend the meeting. In some embodiments, such worker activity information 114 can be obtained based on email data, meeting log data, etc. In other or similar embodiments, such worker activity information 114 can be obtained based on voice or facial recognition techniques employed during the meeting (e.g., by one or more client devices associated with the meeting, etc.). Activity data component 320 can determine that the worker activity information 144 indicating the meeting with the one or more customers is associated with each of the one or more workers that were invited to attended, and/or participated in the meeting and can organize the datasets 352 accordingly. In other or similar embodiments, activity data component 320 can determine that information or collected by or otherwise associated with multiple systems employed by the organization are associated with a common action or activity based on a set of pre-defined rules provided by a leader (e.g., a manager or supervisor) of the organization. For example, a manager of the organization can provide a set of rules associated with worker activity and/or actions to platform 120 via a client device 170. The rules can include an indication of two or more activities or actions of a worker that correspond to a common activity or action and/or do not correspond to a common activity or action. Activity data component 320 can organize the worker activity information 114 into one or more datasets 352 based on the provided rules, in some embodiments.

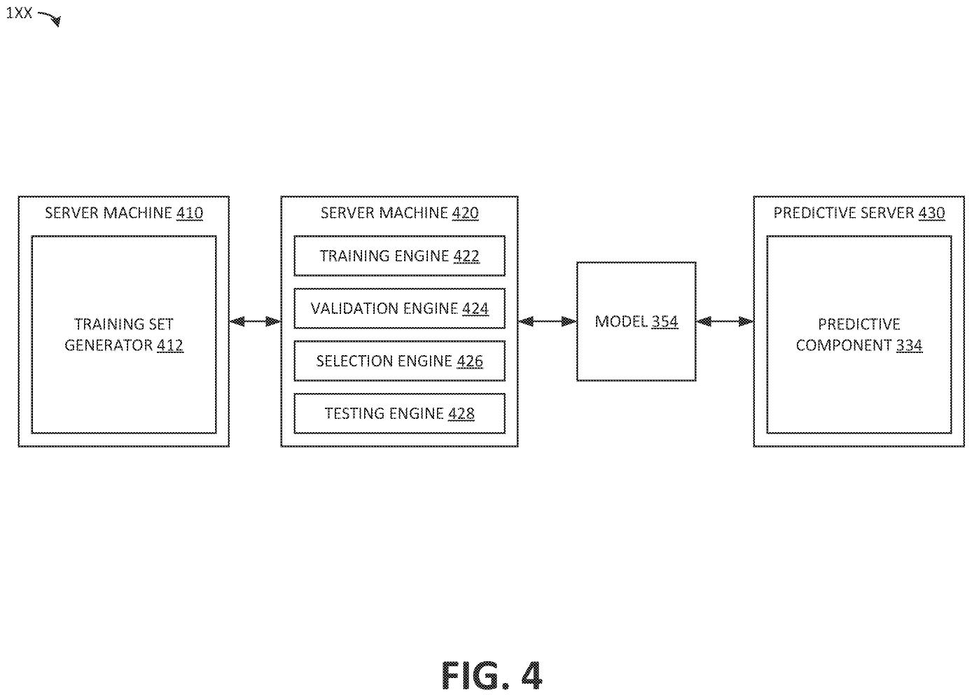

Referring back to FIG. 2, at block 212, processing logic provides the identified data as input to a machine learning model. The machine learning model can be trained to predict, based on given input data indicating actions of workers, a benefaction level associated with the workers relative to other workers of the organization, in some embodiments. In some embodiments, the identified data can include or otherwise correspond to data of datasets 352 at memory 350. As illustrated in FIG. 3, benefaction engine 142 can include a data component 332, a predictive component 334, and/or a benefaction score/rating component 336 (referred to simply as “benefaction score component 336” herein). In some embodiments, data component 332 can obtain the datasets 352 from memory 350. In other or similar embodiments, data component 332 can receive the datasets 352 from activity data component 320 of worker data engine 132 (e.g., via network 102, via a bus, etc.). Predictive component 334 can provide the datasets 352 as input to the machine learning model (e.g., machine learning model 354 at memory 350). In some embodiments, predictive component 334 can be a component of predictive system 160, described above and described with respect to FIG. 4 below. As described above, machine learning model 354 can be trained to predict, based on given input data indicating actions of workers at an organization, a benefaction level associated with the workers relative to other workers of the organization. Model 354 can be trained by one or more components of predictive system 160, as described herein.

FIG. 4 illustrates an example predictive system 160, in accordance with one or more embodiments of the present disclosure. In some embodiments, predictive system 160 can include one or more server machines (e.g., server machine 410, server machine 420, etc.). Predictive system 160 can additionally or alternatively include a predictive server 430. Server machines 410, 420 and/or predictive server 430 can correspond to one or more of server machines 130, 140, 150 of FIG. 1, in some embodiments. In other or similar embodiments, server machines 410, 420, and/or predictive server 430 can be distinct from server machines 130, 140, 150.

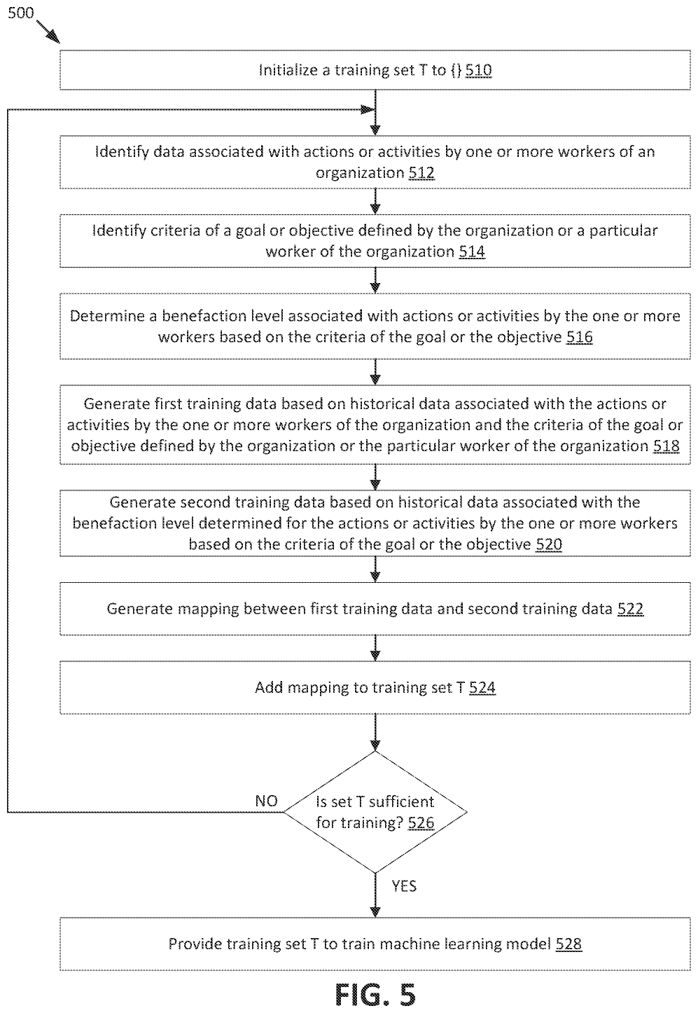

In some embodiments, server machine 410 can include a training set generator 412. Training set generator 412 can be configured to generate one or more training data sets (e.g., a set of data inputs and a set of target outputs) to train, validate, and/or test machine learning model 354. Some operations of training set generator 412 are described in detail below with respect to FIG. 5. In some embodiments, training set generator 412 may partition the training data into a training set, a validating set, and a testing set. Training set generator 412 can generate multiple sets of training data, in accordance with embodiments of the present disclosure.

FIG. 5 is a flow diagram illustrating an example method 500 for training a machine learning model, in accordance with one or more embodiments of the present disclosure. Method 500 can be performed by processing logic that can include hardware (circuitry, dedicated logic, etc.), software (e.g., instructions run on a processing device), or a combination thereof. In one implementation, some or all of the operations of method 500 can be performed by one or more components of predictive system 160 of FIG. 1 and FIG. 4. In some embodiments, some or all of the operations of method 500 can be performed by training set generator 412, as described above.

At block 510 processing logic initializes a training set T to an empty set (e.g., { }). At block 512, processing logic identifies data associated with actions or activities by one or more workers of an organization. The data can correspond to or otherwise include data associated with worker activity information 114, in some embodiments. In accordance with previously described embodiments, the data can be collected by or otherwise associated with one or more systems employed by the organization. The data can correspond to or otherwise include data obtained from one or more systems or platforms that are external to platform 120 (e.g., data from social media platform 180), in some embodiments. In other or similar embodiments, the data can correspond to or otherwise include data provided to platform 120 by a worker of the organization (e.g., via a client device 170).

At block 514, processing logic identifies one or more criteria of a goal or objective defined by the organization or a particular worker of the organization. In some embodiments, the goal or objective (and/or the criteria of the goal or objective), can be provided to platform 120 by a representative of the organization and/or the particular worker of the organization, as described herein. In other or similar embodiments, processing logic can determine the goal or objective (and/or the criteria of the goal or objective) based on goals or objectives defined by other organizations. For example, in some embodiments, platform 120 can serve as a worker management platform for multiple organizations. A first organization associated with platform 120 can provide or otherwise indicate one or more goals or objectives of the first organization and/or one or more criteria associated with the goals or objectives of the first organization. Platform 120 can store an indication of the goals or objectives and/or the associated criteria provided by the first organization at memory 350 or another memory associated with platform 120, in some embodiments. Training set generator 412 can identify the criteria of the goals or objectives defined by the first organization from memory 350, or the other memory, according to operations of block 514, in some embodiments. In other or similar embodiments, training set generator 412 can identify the criteria of a goal or objective defined by an organization (or a worker of the organization) based on information available from publicly accessible sources (e.g., a website that is publicly available via an internet or an intranet, etc.).

At block 516, processing logic determines a benefaction level associated with the actions or activities by the one or more workers based on the criteria of the goal or the objective. As indicated above, a benefaction level can indicate a contribution by a worker to a goal or objective. In some embodiments, processing logic (e.g., training set generator 412) can determine the benefaction level associated with an action or activity by a worker by determining an impact that the action or activity had on meeting the goal or objective based on the criteria of the goal or the objective. The impact of the action or activity can be determined based on information stored at one or more regions of memory associated with platform 120 and/or an organization, information obtained from one or more publicly accessible sources, and/or information provided to platform 120 by a worker of the organization, another user of platform 120, and/or an administrator, designer, etc. of platform 120.

In an illustrative example, a goal or objective of an organization can be for an organization to reduce a carbon footprint of the organization by approximately 5% over a time period of 5 years. The criteria associated with the goal or the objective can include a particular number of airline flights taken by an individual worker or team within the 5 year time period. Training set generator 412 can determine that a worker that takes the particular number of airline flights during the 5 year time period has a neutral impact on the goal or the objective and accordingly can determine that a benefaction level of zero (or approximately zero) is associated with taking the particular number of airline flights during the 5 year time period. Training set generator 412 can further determine that a worker that takes fewer than the particular number of airline flights during the 5 year period has a positive impact on the goal or the objective and accordingly can determine that a benefaction level of more than zero is associated with taking fewer than the particular number of airline flights during the 5 year time period. In some embodiments, the benefaction level for taking fewer than the particular number of flights can increase as the number of flights decreases. Training set generator 412 can further determine that a worker that takes more than the particular number of airline flights during the 5 year period has a negative impact on the goal or the objective and accordingly can determine that a benefaction level of less than zero is associated with taking more than the particular number of airline flights during the 5 year time period.

It should be noted that one or more actions or activities can impact a goal or objective of an organization of a worker. In accordance with the previously illustrative example, additional criteria associated with the goal or objective of reducing a carbon footprint of an organization can include or otherwise relate to a number of days, weeks, etc. that a worker takes public transportation to a location of the organization (e.g., an office) instead of taking private transportation (e.g., driving a personal vehicle) to the location. Training set generator 412 can determine that a worker that takes public transportation to the location for a particular number of days (e.g., as defined by a representative of the organization, etc.) has a neutral impact on the goal or the objective and accordingly can determine that a benefaction level of zero (or approximately zero) is associated with taking public transportation for the particular number of days. Training set generator 412 can additionally or alternatively determine that a worker that takes public transportation to the location for a number of days that exceeds or falls below the particular number of days has a negative impact or a positive impact on the goal or the objective, respectively, and can determine that a benefaction level of less than zero or more than zero is associated with the worker activity, as described above.

At block 518, processing logic generates first training data based on historical data associated with the actions or activities by the one or more workers of the organization and the criteria of the goal or objective defined by the organization or the particular worker of the organization. At block 520, processing logic generates second training data based on historical data associated with the benefaction level determined for the actions or activities by the one or more workers based on the criteria of the goal or the objective. At block 522, processing logic generates a mapping between the first training data and the second training data. The mapping refers to the first training data that includes or is based on the historical data associated with the actions or activities by the one or more workers of the organization and the criteria of the goal or objective defined by the organization or the particular worker of the organization and the second training data associated with the benefaction level determined for the actions or activities by the one or more workers based on the criteria of the goal or the objective.

At block 524, processing logic adds the mapping to the training set T. At block 526, processing logic determines whether training set T is sufficient for training. It should be noted that sufficiency of training set T may be determined based simply on the number of mappings in the training set, while in some other implementations, the sufficiency of training set T may be determined based on one or more other criteria (e.g., a measure of diversity of the training examples, etc.) in addition to, or instead of, the number of input/output mappings. In response to processing logic determining that training set T is insufficient for training, method 500 returns to block 512. In response to processing logic determining that training set T is sufficient for training, method 500 proceeds to block 528. At block 528, processing logic provides the training set T to train the machine learning model.

Referring back to FIG. 4, server machine 420 can include a training engine 422, a validation engine 424, a selection engine 426, and/or a testing engine 428. Training engine 422 may be configured of training machine learning model 354 based on training data generated by training set generator 412, as described above. Machine learning model 354 may refer to the model artifact that is created by the training engine 422 using the training data that includes training inputs and corresponding target outputs (correct answers for respective training inputs). The training engine 422 may find patterns in the training data that map the training input to the target output (the answer to be predicted), and provide the machine learning model 354 that captures these patterns. The machine learning model 354 may use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), etc.

The validation engine 424 may be capable of validating a trained machine learning model 354 using a corresponding set of features of a validation set from training set generator 412. The validation engine 424 may determine an accuracy of each of the trained machine learning models 354 based on the corresponding sets of features of the validation set. The validation engine 424 may discard a trained machine learning model 354 that has an accuracy that does not meet a threshold accuracy. In some embodiments, the selection engine 426 may be capable of selecting a trained machine learning model 354 that has an accuracy that meets a threshold accuracy. In some embodiments, the selection engine 426 may be capable of selecting the trained machine learning model 354 that has the highest accuracy of the trained machine learning models 354.

The testing engine 428 may be capable of testing a trained machine learning model 354 using a corresponding set of features of a testing set from training set generator 412. For example, a first trained machine learning model 354 that was trained using a first set of features of the training set may be tested using the first set of features of the testing set. The testing engine 428 may determine a trained machine learning model 354 that has the highest accuracy of all of the trained machine learning models based on the testing sets.

Predictive server 430 includes predictive component 334 that is capable of providing data indicating an activity or action associated with one or more workers of an organization as input to trained machine learning model 354 and running trained machine learning model 354 on the input to obtain one or more outputs. Referring back to FIG. 2, at block 214, processing logic obtains one or more outputs of the machine learning model. The one or more outputs can indicate a respective benefaction level for each of the workers relative to other workers of the organization. In some embodiments, processing logic can correspond to predictive component 334 of benefaction engine 142. Predictive component 334 can obtain the one or more outputs of machine learning model 354, as described above.

At block 216, processing logic extracts a benefaction level for each of the workers from the one or more outputs. In some embodiments, processing logic can correspond to predictive component 334 of benefaction engine 142 and/or benefaction score component 336 of benefaction engine 142. In some embodiments, the one or more outputs of the machine learning model 354 can include an indication of a benefaction level for each of the workers of the organization in view of a particular goal or objective associated with the organization. In such embodiments, processing logic can extract the benefaction level for the one or more outputs for the workers of the organization by identifying a benefaction level determined for each respective worker of the one or more outputs. In additional or alternative embodiments, the one or more outputs include an indication of multiple benefaction levels for each of the workers of the organization in view of a particular goal or objective and, for each of the multiple benefaction levels, a level of confidence that a respective benefaction level is associated with actions or activities of a respective worker of the organization. The processing logic can extract the benefaction level for a respective worker of the organization by identifying a benefaction level having a level of confidence that satisfies one or more confidence criteria (e.g., exceeds level of confidence threshold, is larger than other levels of confidence, etc.). In other or similar embodiments, the one or more outputs of the machine learning model 354 can include an indication of a benefaction level for a particular worker of the organization in view of a particular goal or objective associated with the particular worker. The processing logic can extract the benefaction level by identifying the benefaction level for the particular worker, as indicated by the one or more outputs. In yet other or similar embodiments, the one or more outputs can include an indication of multiple benefaction levels for the particular worker in view of the particular goal or objective associated with the particular worker. Processing logic can extract the benefaction level by identifying the benefaction level having a level of confidence that satisfies the one or more confidence criteria.

In some embodiments, benefaction score/rating component 336 can determine a benefaction score or rating associated with the actions or activities of a worker based on the benefaction level for the worker extracted from the one or more outputs of the machine learning model 354. A benefaction score or rating can include or be represented as an alphanumerical value, a symbol, etc. that indicates a benefaction level associated with a worker of an organization relative to other workers of the organization. In an illustrative example, a benefaction score or rating can be a number between 0.00 and 1.00 that indicates a benefaction level associated with a worker relative to other workers of the organization (e.g., a score or rating of 0.00 representing a low benefaction level and a score or rating of 1.00 representing a high benefaction level). In another illustrative example, the benefaction score or rating can be a number between −1.00 and 1.00 that indicates the benefaction level associated with the worker relative to other workers of the organization (e.g., a negative score or rating representing negative benefaction, a score or rating of 0.00 representing a neutral benefaction, and/or a positive score or rating representing a positive benefaction). In some embodiments, benefaction score/rating component 336 can determine the benefaction score or rating associated with the actions or activities of the worker by providing an indication of the benefaction level determined for one or more workers of the organization (e.g., all workers of the organization or a subset of workers of the organization) as input to a normalization function and obtaining one or more values as an output of the normalization function that represent the normalized benefaction levels for each of the one or more workers. The normalized benefaction levels can correspond to otherwise indicate a benefaction score or rating associated with the one or more workers. In some embodiments, benefaction score/rating component 336 can store an indication of a benefaction score 356 at memory 350.

In some embodiments, benefaction score/rating component 336 can categorize the benefaction scores associated with actions or activities of multiple workers. For example, benefaction score/rating component 336 can define a first category of benefaction scores or ratings as “leader” or “platinum level” scores or ratings. Benefaction scores or ratings can be included in the first category of benefaction scores or ratings in response to the benefaction scores meeting or exceeding a first threshold benefaction score or rating. In another example, benefaction score/rating component 336 can define a second category of benefaction scores or ratings as “team contributor” or “gold level” scores. Benefaction scores or ratings can be included in the second category of benefaction scores or ratings in response to the benefaction scores or ratings falling below the first threshold benefaction score or rating but meeting or exceeding a second threshold benefaction score or rating. Benefaction score/rating component 336 can define any number or type of category (e.g., “silver level” scores, etc.), as described above.

In some embodiments, platform 120 can provide an indication of a benefaction score/rating 336 associated with a worker of an organization to digital badge engine 152 (e.g., via network 102, via a bus, etc.). FIG. 6 illustrates an example digital badge engine 156, according to one or more embodiments of the present disclosure. As indicated above, digital badge engine 152 can be configured to issue one or more digital badges to workers (or teams of workers) based on a benefaction level associated with the workers (or the teams of workers). A digital badge refers to or can otherwise include a digital asset that can indicate whether a benefaction level associated with a worker satisfies one or more criteria associated with a goal or objective associated with the organization. In some embodiments, digital badge engine 156 can include a badge issuance component 622, a database manager component 624, a data management component 626, a worker profile component 628, a worker recommendation component 630 and/or a team badge module 632.

In some embodiments, digital badge engine 152 can obtain an indication of a benefaction score/rating 356 associated with a worker of an organization. The benefaction score/rating 356 can indicate a benefaction level of the worker with respect to one or more goals or objectives of the organization and/or the particular worker, as described above. In some embodiments, digital badge engine 152 can receive the indication of the benefaction score/rating 356 from platform 120 (e.g., via network 102, via a bus, etc.). In other or similar embodiments, digital badge engine 152 can obtain the indication of the benefaction score/rating 356 from memory 350 (or another memory of system 100 accessible to digital badge engine 152).

Referring back to FIG. 2, at block 218, processing logic determines that a benefaction level for a respective worker satisfies one or more criteria associated with a goal or objective defined by at least one of the respective worker or the organization. In some embodiments, processing logic can correspond to digital badge engine 152. As described above, a representative or worker of an organization can provide an indication of one or more goals or objectives. For example, a representative or worker of the organization can provide an indication of the one or more goals or objectives via a GUI of a client device 170. The representative or worker can additionally or alternatively provide an indication of the criteria associated with the goals or objectives, in some embodiments. Platform 120 can receive or otherwise obtain (e.g., via network 102) the indication of the goals or objectives and/or the corresponding criteria as goal data 602. In some embodiments, platform 120 can store the goal data 602 at memory 350 (or another memory of or otherwise connected to system 100).

In some embodiments, badge issuance component 622 of digital badge engine 152 can be configured to issue a digital badge to a worker (or team of workers) based on a benefaction level associated with the worker. Badge issuance component 622 can identify a benefaction score/rating 356 determined for a particular worker (or team of workers) and goal data 602 associated with a goal or objective defined by the organization or the particular worker. In some embodiments, badge issuance component 622 can identify the benefaction score/rating 356 and/or the goal data 602 from memory 350. Badge issuance component 622 can determine whether the one or more criteria associated with the goal or objective are satisfied based on the benefaction score/rating 356 associated with the particular worker and, if so, can issue a digital badge to the particular worker. In an illustrative example, a goal associated with reducing a carbon footprint of the organization can be associated with one or more criteria of a particular number of airline flights taken by an individual worker, a particular number of days, weeks, etc. in which a worker takes public transportation to the location of the organization, and so forth. The benefaction score/rating 356 for a respective worker of the organization can indicate a benefaction level that actions or activities of the worker have with respect to the criteria of the goal or objective. A benefaction level that meets or exceeds a threshold benefaction level (e.g., defined by goal data 602) can indicate that the actions or activities of the worker satisfy the criteria of the goal or the objective (e.g., that the worker has taken fewer than the particular number of flights, that the worker has taken public transportation for more than the particular number of days, etc.). Accordingly, badge issuance component 622 can determine that the criteria of the goal or the objective are satisfied and can issue a digital badge associated with the goal or objective to the worker.

Referring back to FIG. 2, at block 220, processing logic updates a digital badge database to indicate that a digital badge is issued to the respective worker. The digital badge indicates that the respective benefaction level for the respective worker satisfies the one or more criteria associated with the goal or objective of the organization. In some embodiments, database manager component 624 can update a digital badge database 122 to include worker badge data 254 and/or team badge data 256 in response to badge issuance component 622 issuing a digital badge to a worker or team of workers. In some embodiments, digital badge database 122 can include one or more entries that each correspond to a respective worker (or team of workers) of an organization. Database manager component 624 can identify an entry of digital badge database 122 that corresponds to the respective worker (or team of workers) and can update the entry to include an indication of the digital badge issued to the worker (or team of workers). In other or similar embodiments, entries of digital badge database 122 can correspond to digital badges issued by badge issuance component 622. In such embodiments, database manager component 624 can update digital badge database 122 by adding an entry that corresponds to the digital badge issued by badge issuance component 622 for a respective worker (or team of workers).

Each entry of digital badge database 122 (whether corresponding to a worker, a digital badge, etc.) can be associated with a respective index value. The index value can be used by one or more components or modules described herein to access (e.g., read, modify, update, etc.) entries of the database 122 in some embodiments. In some embodiments, the indices of database 122 can indicate a logical ordering of entries or data of database 122. Data of database 122 can be organized according to a clustered organizational scheme or a non-clustered organizational scheme, in some embodiments. In some embodiments, an index associated with entries of database 122 can include or otherwise correspond to a bitmap index, a dense index, a sparse index, a reverse index, a primary index, a secondary index, and/or a hash index.

As illustrated in FIG. 6, digital badge database 122 can include worker badge data 254 and/or team badge data 256. In some embodiments, worker badge data 254 can include an indication of a digital badge issued to a worker of an organization, an identifier associated with the worker, a timestamp indicating when the digital badge was issued to the worker, an indication of one or more criteria that were satisfied by the actions or activities of the worker, and/or other data relating to the worker, the digital badge, and/or the goal or objective associated with the digital badge. In some embodiments, team badge data 256 can include an indication of a digital badge issued to a team of an organization, a timestamp indicating when the digital badge was issued to the worker, an indication of a time period for which the digital badge is associated, an identifier associated with one or more workers of the team, an indication of one or more criteria that were satisfied by actions or activities of the worker, and/or other data relating to the team, workers of the team, the digital badge, and/or the goal or objective associated with the digital badge.

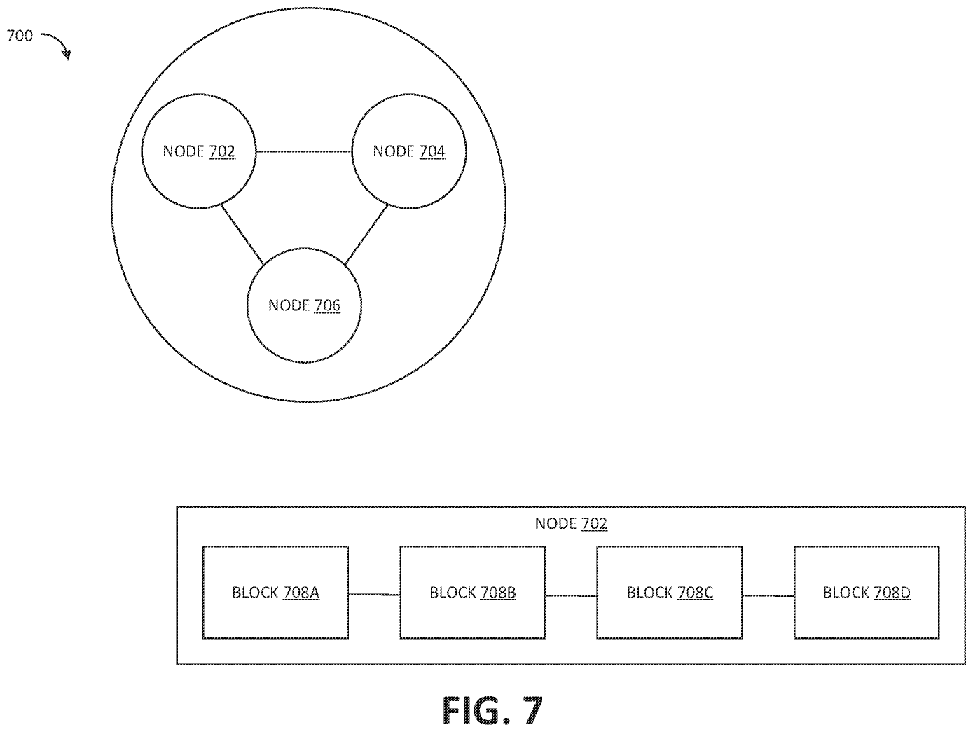

It should be noted that digital badge database 122 can include any type of database structure, including but not limited to a relational database structure (e.g., a collection of data items with pre-defined relationships between them), a non-relational database structure, a linked data model, and so forth. In some embodiments, digital badge database 122 can include or otherwise correspond to a distributed ledger network, such as a block chain network. FIG. 7 depicts an example distributed ledger network 700, in accordance with embodiments of the present disclosure. In some embodiments, distributed ledger network 700 can include one or more nodes (e.g., node 702, node 704, node 706) that maintain one or more portions of a distributed ledger. A distributed ledger 700 can be a blockchain, in some embodiments. A blockchain is a type of distributed ledger that is used, for example, in a Bitcoin crypto-currency system. The blockchain is a data structure including a complete history of each block 708 in the distributed ledger network 700 from the first block (e.g., block 708A) to the most recently added block (e.g., block 708D). Each node of the distributed ledger network 700 can maintain a copy of all or a portion of the distributed ledger in storage (e.g., on disk or in RAM) that is local to the node. For example, each node 702, 704, and/or 706 can receive a copy of the distributed ledger upon joining the network. In accordance with embodiments described herein, nodes 702, 704, and/or 706 can correspond to one or more blockchain clients. In some embodiments, distributed ledger can be a public ledger that is maintained by distinct individual computer systems each operated by different entities that maintain a single blockchain. In additional or alternative embodiments, the distributed ledger can be maintained by one or more individual computing system that are operated by a single entity (e.g., a private or a closed system).

Nodes 702, 704, and/or 706 can sequentially record data into the distributed ledger of distributed ledger network 700 as blocks of data. For example, each of nodes 702, 704, and/or 706 can be operated to “process” blocks 708 (e.g., blocks 708A, 708B, 708C, 708D) of the distributed ledger by validating data associated with each block 708. In some embodiments, only one node receives data that has been broadcasted over a network (e.g., by worker management platform 120). Once the node receives the data, it can propagate the data to other participating nodes of the distributed ledger network 700. The other participating nodes can add the data to their copy of the distributed ledger.

Nodes 702, 704, and/or 706 can validate a new block that is added to the distributed ledger network 700 by applying an operation to data of the block. The operation can involve solving a computationally difficult problem that can be verified easily (e.g., using minimal computing resources). In some embodiments, the operation can be a hash operation. In an illustrative example, each node of distributed ledger network 700 can execute instructions (e.g., via one or more processing devices of a local computing system of the node) to attempt to compute a hash value for a respective block 708 of the node using a cryptographic hash function (e.g., a secure hash algorithm (SHA)-256 function, etc.). An input to the hash function can include data associated with the block 708, in some embodiments and an output of the hash function can include hash value that represents the data of the block 708. Nodes 702, 704, and/or 706 can build blocks 708 that include a reference (e.g., a data pointer) to the hash value of the previously block 708 of the distributed ledger. As such, blocks 708 of the distributed ledger are explicitly ordered by reference to the previous blocks' hash value, which reflects the content of that previous block. In an illustrative example, block 708B is explicitly ordered by reference to the hash value of block 708A, block 708C is explicitly ordered by reference to the hash value of block 708B, block 708D is explicitly ordered by reference to the hash value of block 708C, and so forth.

It should be noted that although embodiments of the present disclosure describe distributed ledger network 700 as a blockchain, distributed ledger network 700 can include other types of distributed ledgers, in accordance with embodiments of the present disclosure. It should be further noted that although FIG. 7 depicts three nodes (e.g., nodes 702, 704, and 706) of distributed ledger network 700, distributed ledger network 700 can include any number of nodes. In addition, although FIG. 7 depicts node 702 as including four blocks (e.g., blocks 708A, 708B, 708C, and 708D), nodes 702, 704, and/or 706 can include any number of blocks. Further, any embodiments described respect to node 702 above can be applied to any other node (e.g., node 704, 706, etc.) of distributed ledger network 700.

In such embodiments, database manager component 624 can update database 122 by appending badge data (e.g., worker badge data 254, team badge data 256, etc.) associated with a respective worker or team of workers to a data block (e.g., block 708) of the blockchain (e.g., distributed ledger 700) and broadcasting the data block 708 to one or more blockchain nodes 702.

Referring back to FIG. 6, data management component 626 can be configured to remove (e.g., erase, etc.) data associated with one or more actions or activities of a worker or team of workers from data store(s) 112 in response to a digital badge being issued to the worker or team of workers and/or database manager component 624 updating digital badge database 122 to include an indication of the issued digital badge, as described above. In an illustrative example, badge issuance component 622 can issue a digital badge to a worker (or team of workers) based on one or more actions or activities associated with the worker (or team of workers). In response to badge issuance component 622 issuing the digital badge and/or database manager component 624 updating digital badge database 122 to include an indication of the digital badge, data management component 626 can parse data store(s) 112 to identify data associated with the action or activity and, in some instances, can remove (e.g., erase) the identified data from data store(s) 112.

As described above, platform 120 can maintain one or more profiles associated with workers of an organization. A profile can include information associated with the worker, including, in some embodiments, an indication of one or more digital badges issued to the worker (e.g., by digital badge engine 152). In some embodiments, a user of platform 120 (e.g., a worker, a supervisor or manager, etc.) can request access to a profile associated with a worker via a GUI of a client device 170. The client device 170 can receive the request from the user and can transmit or forward the request to platform 120. Worker profile component 628 of digital badge engine 152 can receive the request (or information of the request) from platform 120 and can determine a worker associated with the request. Worker profile component 628 can identify worker profile data 604 associated with the determined worker at memory 350 and can provide the worker profile data 604 to platform 120 in response to the request.

In some embodiments, worker profile data 604 can include an indication of one or more digital badges issued to the worker, as described above. For example, worker profile data 604 can include a mapping to an entry of digital badge database 122 corresponding to the worker and/or a digital badge issued to the worker. In another example, worker profile data 604 can include an indication of an index value associated with an entry of digital badge database 122 corresponding to the worker and/or the digital badge issued to the worker. Worker profile component 628 can identify an entry of digital badge database 122 (e.g., based on the mapping or indicated index value) and can determine one or more digital badges issued to the worker from the identified entry. Worker profile component 628 can include an indication of the one or more digital badges to platform 120 with worker profile data 604. In some embodiments, platform 120 can update a GUI at a client device 170 that provided the request for the worker profile to include worker profile data 604 and/or an indication of the one or more digital badges. In additional or alternative embodiments, the worker profile data 604 can indicate one or more categories associated with the benefaction scores for the worker that led to the issuance of the digital badges. For example, a worker may have been issued a digital badge in response to a benefaction score for the worker meeting or exceeding a first threshold associated with a first category of benefaction scores. The worker profile data 604 can therefore indicate that the benefaction score for the worker is at a “leader” or “platinum” level. Platform 120 can update the GUI at client device 170 based on this additional information. In yet additional or alternative embodiments, the worker profile data 604 can include a badge history of the worker. Platform 120 can further update the GUI at client device 170 to indicate the badge history of the worker and/or a trend of the badge history of the worker. In some embodiments, the trend of the badge history of the worker can indicate a change of the benefaction score from a first category to a second category.

As illustrated in FIG. 6, and described with respect to FIG. 1, platform 120 and/or digital badge engine 152 can be connected to social media platform 180, in some embodiments. Social media platform 180 can maintain one or more profiles associated with users of the platform 180, which can include workers of an organization and/or other users that are not workers of the organization and/or are not otherwise associated with the organization. In some embodiments, a worker of an organization can request (e.g., via a GUI of a client device 170) that one or more digital badges issued to the worker by digital badge engine 152 be included in a profile for the worker maintained by social media platform 180. Client device 170 can transmit or otherwise forward the request to platform 120, in some embodiments. One or more components of digital badge engine 152 (e.g., worker profile component 628, etc.) can identify an entry that corresponds to the worker that provided the request and can determine one or more digital badges associated with the worker from the identified entry, as described herein. Platform 120 and/or digital badge engine 152 can provide an indication of the digital badges associated with the worker to social media platform 180 (e.g., via network 102). In some embodiments, platform 180 and/or digital badge engine 152 can provide the indication of the digital badges associated with the worker to social media platform 180 via an API between platform 120 and platform 180. Platform 180 can update a profile associated with the worker to include an indication of the digital badges, in some embodiments.

In other or similar embodiments, client device 170 can transmit or otherwise forward the request to platform 180. Platform 180 can forward the request (or generate a new request and transmit the new request) to platform 120, in some embodiments. In such embodiments, platform 120 can determine the one or more badges associated with the worker and can provide the indication of the determined one or more badges to platform 180, as described herein. In other or similar embodiments, platform 180 can access digital badge database 122 (e.g., via network 102, via an API between platform 180 and digital badge database 122, etc.) and can identify one or more entries corresponding to the worker and/or digital badges issued to the worker. In response to identifying the one or more entries, platform 180 can determine the one or more digital badges issued to the worker and can update a profile associated with the worker to include an indication of the digital badges, as described above.

In some embodiments, worker recommendation component 630 can use worker badge data 254 and/or team badge data 256 of digital badge database 122 to provide recommendations and/or insights to leaders of the organization (e.g., supervisors, managers, etc.) of one or more actions to be taken with respect to a particular worker (or team of workers). For example, platform 120 (or another platform or engine of system 100) can include a worker performance engine (not shown) that is configured to determine one or more actions to be taken with respect to a worker (or team of workers) based on worker data during a particular time period. The worker data can include data that directly relates to a function or role of the worker at the organization and/or can include additional information (such as worker activity information, worker badge data 254, etc.). In some embodiments, platform 120 can receive a request from the worker performance engine for one or more digital badges associated with a particular worker. Digital badge engine 152 can determine one or more digital badges associated with the worker, as described above, and can provide an indication of the one or more digital badges to the worker performance engine, in response to the request. In some embodiments, the worker performance engine can determine one or more actions to be taken with respect to the worker (e.g., whether the worker is to be promoted, whether the worker is to be terminated, whether a compensation package and/or a role of the worker is to be modified, etc.) based on the one or more digital badges.

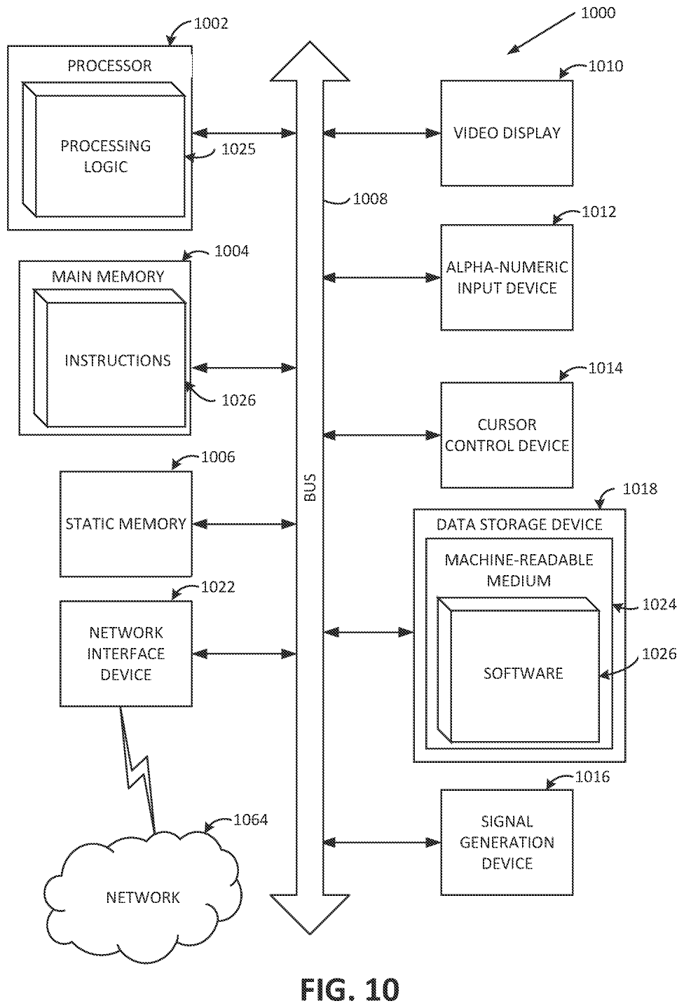

As illustrated in FIG. 6, digital badge engine 152 can include a team badge component 632, in some embodiments. Team badge component 632 can be configured to determine a digital badge associated with a worker of an organization based on one or more badges issued to a team of workers that includes the worker. Further details regarding team badge component 632 are provided with respect to FIG. 10.

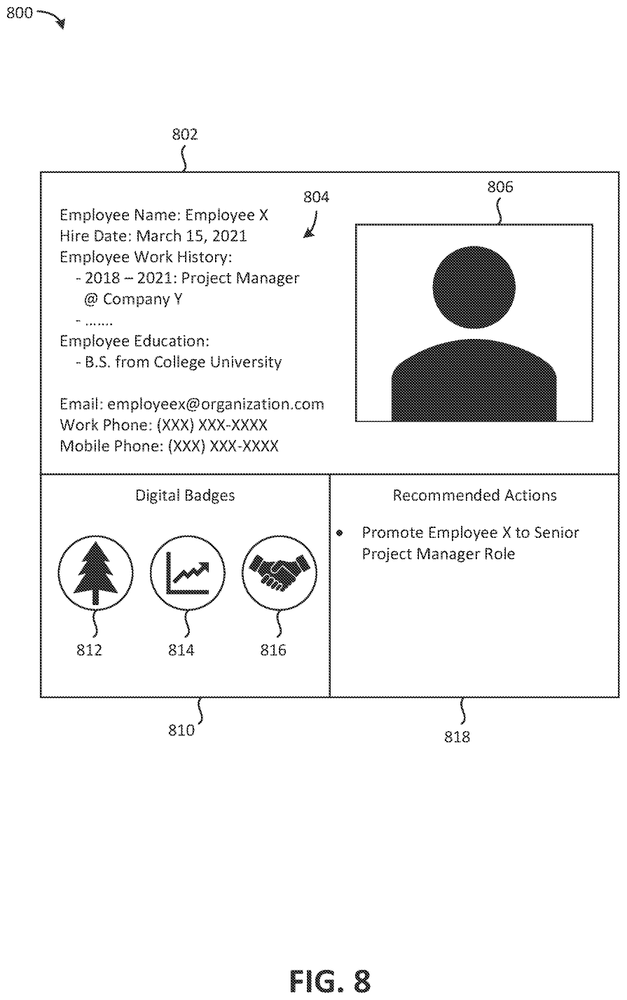

FIG. 8 depicts an example graphical user interfaces (GUIs), in accordance with one or more embodiments of the present disclosure. In particular, FIG. 8 depicts an example GUI 800 of a profile associated with a worker of an organization. As illustrated in FIG. 8, GUI 800 can include one or more sections (e.g., section 802, section 810, section 818, etc.). In some embodiments, section 802 can include information 804 associated with the worker. The information 804 can include a name of the worker (e.g., “Employee X”), a hire date of the worker (e.g., “Mar. 15, 2021”), a work history of the worker, an education of the worker, contact information associated with the worker (e.g., an electronic mail address, a work phone number, a mobile phone number, etc.), and so forth. In additional or alternative embodiments, section 802 can include an image 806 of the worker. Information 804 and/or image 806 can be included with or otherwise indicated by worker profile data 604, in some embodiments.

In some embodiments, section 810 (or another section of GUI 800) can include one or more GUI elements (e.g., GUI element 812, GUI element 814, GUI element 816, etc.) that indicate one or more digital badges issued to a worker associated with the worker profile. As illustrated in the example GUI 800 of FIG. 8, section 810 can include a first GUI element 812 indicating a first digital badge issued to the worker, a second GUI element 814 indicating a second digital badge issued to the worker, and/or a third GUI element 816 indicating a third digital badge issued to the worker. In some embodiments, GUI elements 812, 814, and/or 816 can include an icon, an image, a design, etc. that corresponds to the goal or objective (or the criteria of the goal or objective) associated with the digital badge represented by the GUI element. For example, GUI element 812 can represent a digital badge associated with the goal or objective of reducing a carbon footprint of the organization. The icon, image, design, etc. of the GUI elements can be provided to platform 120 by a representative of the organization and/or a particular worker of the organization, in some embodiments. In other or similar embodiments, the icon, image, design, etc. of the GUI elements can be generated by a component or engine of platform 120. Platform 120 can obtain the icon, image, design, etc. of the GUI elements according to other techniques, in additional or alternative embodiments.

In some embodiments, section 818 can include one or more GUI elements that indication one or more recommended actions to be taken with respect to a worker associated with the profile. The recommended actions can be determined or otherwise obtained by a worker performance engine, according to embodiments described above. As illustrated in the example GUI 800 of FIG. 8, section 818 can indicate that a recommended action for the worker associated with the profile is to “promote employee X to senior project manager role.” As described above, the recommended action can be determined in view of the one or more digital badges issued to the worker, in some embodiments. In some embodiments, a user that is accessing a profile of a worker can be a leader of the organization, such as a supervisor or manager of the worker. In such embodiments, section 818 and/or data or information of section 818 can be included in GUI 800. In other or similar embodiments, a user that is accessing a profile of a worker can be the worker. In such embodiments, section 818 and/or data or information of section 818 may not be included in GUI 800.

As described above, benefaction engine 142 can determine a benefaction level of a team of workers (rather than an individual worker) based on actions or activities of the team of works, in some embodiments. In such embodiments, digital badge engine 152 can issue one or more digital badges to the team of workers rather than each individual worker of the team, as described herein.

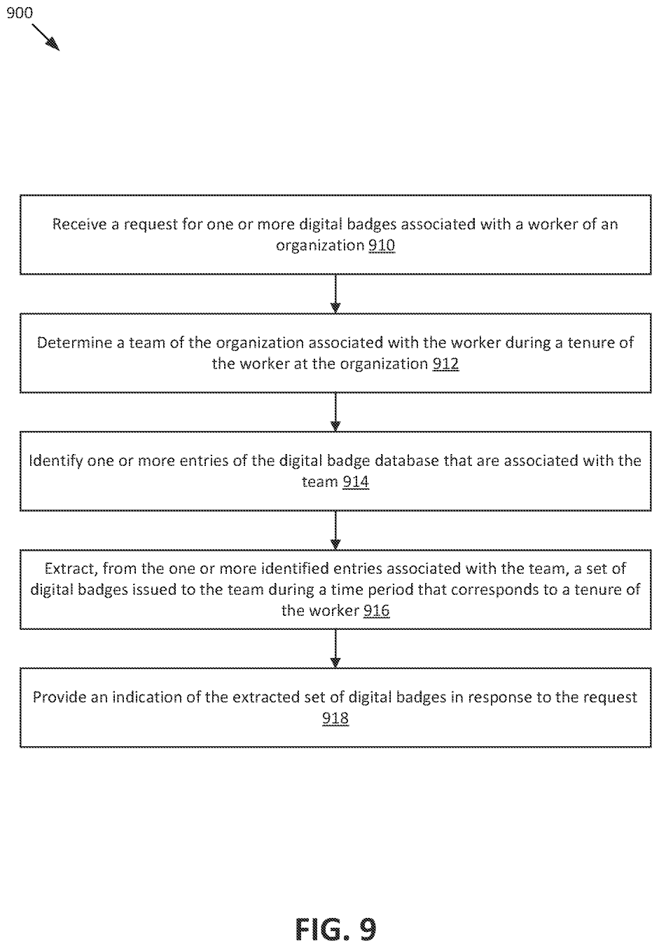

FIG. 9 is a flow diagram illustrating an example method 900 for determining a digital badge associated with a worker based on digital badges issued to a team of an organization, in accordance with one or more embodiments of the present disclosure. Method 900 can be performed by processing logic that can include hardware (circuitry, dedicated logic, etc.), software (e.g., instructions run on a processing device), or a combination thereof. In one implementation, some or all of the operations of method 900 can be performed by one or more components of system 100 of FIG. 1. In some embodiments, some or all of the operations of method 900 can be performed by worker management platform 120, as described above. For example, some or all of the operations of method 900 can be performed by worker data engine 132 and benefaction engine 142 of FIG. 1 and FIG. 3 and/or digital badge engine 152 of FIG. 1 and FIG. 6, in some embodiments. In some embodiments, some or all of the operations of method 900 can be performed by team badge component 632 of digital badge engine 152.

At block 910, processing logic receives a request for one or more digital badges associated with a worker of an organization. In some embodiments, a user of platform 120 (e.g., a worker, a supervisor, etc.) can request access to a profile associated with the worker via a GUI of client device 170. Client device 170 can transmit or forward the request to platform 120, in some embodiments. In other or similar embodiments, the request can be received from platform 180.

At block 912, processing logic determines a team of the organization associated with the worker during a tenure of the worker at the organization. A tenure of a worker at an organization refers to a time period during which the worker provides services to the organization in accordance with a role or function of the worker. In some embodiments, team badge component 632 of digital badge engine 152 can determine the team of the organization associated with the worker by accessing worker profile data 604 of memory 350. Worker profile data 604 can indicate a team that includes or included the worker during at least a portion of the tenure of the worker. Team badge component 632 can determine a team of the organization associated with the worker according to other techniques, in additional or alternative embodiments.

At block 914, processing logic identifies one or more entries of a digital badge database that are associated with the team. As described above, badge issuance component 622 can issue one or more digital badges to a team of workers rather than an individual worker of an organization, in some embodiments. Database manager component 624 can update digital badge database 122 to indicate the digital badges issued to the team by adding or otherwise updating an entry associated with the team or the digital badges to indicate the digital badges are issued to the team. In some embodiments, the one or more digital badges issued to the team can be indicated by team badge data 360 at digital badge database 122. Team badge component 632 can identify one or more entries of digital badge database 122 that correspond to the team that includes or included the worker, in accordance with previously described embodiments.

At block 916, processing logic extracts, from the identified one or more entries associated with the team, a set of digital badges issued to the team during a time period that corresponds to a tenure of the worker. In some embodiments, the entries identified by team badge component 632 can include multiple digital badges issued to the team. One or more of the multiple digital badges may have been issued to the team during the tenure of the worker, while other digital badges may have been issued to the team outside of the tenure of the worker. Team badge component 632 can determine whether each digital badge of the one or more identified entries was issued to the team based on activities or actions performed by the team of workers during a tenure of the worker based on information of team badge data 360. In some embodiments, team badge component 632 can include the digital badges that were issued to the team based on activities or actions performed during the tenure of the worker in the set of digital badges.

At block 918, processing logic provides an indication of the extracted set of digital badges in response to the request. In some embodiments, team badge component 632 can provide the indication of the extracted set of digital badges to platform 120 and platform 120 can transmit the indication of the extracted set of digital badges to client device 170 and/or platform 180, in response to the request. In other or similar embodiments, team badge component 632 can update worker profile data 604 associated with the worker to include the indication of the extracted set of digital badges, as described above. In yet other or similar embodiments, team badge component 632 can provide the indication of the extracted set of digital badges to the social media platform 180 (e.g., via network 102, via an API between platform 120 and platform 180, etc.).

In some embodiments, platform 120 can maintain a counter associated with a profile for the particular worker. The counter can indicate a number of requests from the application for digital badges associated with the worker. In response to receiving the request from the application, platform 120 can increment the counter (e.g., by a value of 1 or approximately 1) in accordance with the received request. In some embodiments, platform 120 can determine whether to maintain the one or more digital badges associated with the worker at the platform based on the value of the incremented counter. For example, if the counter indicates that a number of requests for digital badges associated with the worker falls below a threshold number of requests (e.g., during a particular time period), platform 120 can determine that an external interest in the digital badges is low and may determine that platform 120 should no longer support or offer such digital badges. If, however, the counter indicates that a number of requests for the digital badges meets or exceeds the threshold number of requests (e.g., during the particular time period), platform 120 can determine that an external interest in the digital badges is high and may determine that platform 120 should continue to offer or support such digital badges. In some embodiments, the counter can correspond to the digital badge itself, rather than a particular worker. In such embodiments, the digital badge can represent a number of requests received from application to access such badge at profiles associated with any worker of the organization.

It should be noted that digital badges issued for a worker, or team of workers, can be used for other purposes other than providing an indication of a benefaction level of a worker or team of workers for a goal or objective of an organization. In some embodiments, a machine learning model (not shown) can be trained based on historical data associated with digital badges issued to workers to provide a recommendation to a worker of an organization of one or more actions or activities that should be performed by the worker in order to satisfy one or more goals or objectives of the organization. The digital badges issued to workers or teams of workers of an organization can be used according to other techniques, in accordance with embodiments of the present disclosure.

FIG. 10 is a block diagram illustrating a computing system 1000 in which implementations of the disclosure can be used. In certain implementations, computer system 1000 can be connected (e.g., via a network, such as a Local Area Network (LAN), an intranet, an extranet, or the Internet) to other computer systems. Computer system 1000 can operate in the capacity of a server or a client computer in a client-server environment, or as a peer computer in a peer-to-peer or distributed network environment. Computer system 1000 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

The computer system 1000 includes a processing device 1002, a main memory 1004 (e.g., read-only memory (ROM), flash memory, dynamic random access memory (DRAM) (such as synchronous DRAM (SDRAM) or DRAM (RDRAM), etc.), a static memory 1006 (e.g., flash memory, static random access memory (SRAM), etc.), and a data storage device 1016, which communicate with each other via a bus 1008.

Processing device 1002 represents one or more general-purpose processing devices such as a microprocessor, central processing unit, or the like. More particularly, the processing device can be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 can also be one or more special-purpose processing devices such as an application specific integrated circuit (ASIC), a field programmable gate array (FPGA), a digital signal processor (DSP), network processor, or the like. The processing device 1002 is to execute the instructions 1026 for performing the operations and steps discussed herein.

The computer system 1000 can further include a network interface device 1022 communicably coupled to a network 1025. The computer system 1000 also can include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1016 (e.g., a speaker).

Instructions 1026 can reside, completely or partially, within volatile memory 1004 and/or within processing device 1002 during execution thereof by computer system 1000, hence, volatile memory 1004 and processing device 1002 can also constitute machine-readable storage medium 1024. Data storage device 1016 can include a computer-readable storage medium 1024 (e.g., a non-transitory computer-readable storage medium) on which can store instructions 1026 encoding any one or more of the methods or functions described herein, including instructions for implementing method 200 of FIG. 3, method 500 of FIG. 5, and/or method 900 of FIG. 9.

The non-transitory machine-readable storage medium 1024 can also be used to store instructions 1026 to support caching results of certain commands utilized for maintaining passwords for network-accessible service accounts described herein, and/or a software library containing methods that call the above applications. While the machine-accessible storage medium 1024 is shown in an example implementation to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding, or carrying a set of instruction for execution by the machine and that cause the machine to perform any one or more of the methodologies of the disclosure. The term “machine-accessible storage medium” shall accordingly be taken to include, but not be limited to, solid-state memories, and optical and magnetic media.

Unless specifically stated otherwise, terms such as “receiving,” “invoking,” “associating,” “providing,” “storing,” “performing,” “utilizing,” “deleting,” “initiating,” “marking,” “generating,” “transmitting,” “completing,” “executing,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and does not have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 200, 500 and 900 and/or each of its individual functions, routines, subroutines, or operations. Examples of the structure for a variety of these systems are set forth in the description above.

The above description is intended to be illustrative, and not restrictive. Although the disclosure has been described with references to specific illustrative examples and implementations, it should be recognized that the disclosure is not limited to the examples and implementations described. The scope of the disclosure should be determined with reference to the following claims, along with the full scope of equivalents to which the claims are entitled.

What is claimed is:

1. A method comprising:
receiving, by a platform, a request for one or more digital badges associated with a particular worker of a plurality of workers of an organization;
determining, by the platform, a team of the organization associated with the particular worker during a tenure of the particular worker at the organization;
identifying, by the platform, one or more entries of a digital badge database that are associated with the team, wherein the one or more entries indicate one or more digital badges issued to the team based on a benefaction level determined for workers of the team;
extracting, by the platform and from the identified one or more entries associated with the team, a set of digital badges issued to the team during a time period that corresponds to a tenure of the particular worker; and
providing, by the platform, an indication of the extracted set of digital badges in response to the request.

2. The method of claim 1, wherein the request is received from an application that hosts a profile associated with the particular worker, wherein users of the application can access information associated with the particular worker via the profile.

3. The method of claim 2, wherein the application hosting the profile associated with the particular worker is associated with at least one of the organization or a social media platform.

4. The method of claim 2, further comprising:
responsive to receiving the request from the application, incrementing a counter associated with the profile associated with the particular worker, wherein the counter indicates a number of requests from the application for the one or more digital badges associated with the particular worker; and
determining, based on a value of the incremented counter, whether the maintain the one or more digital badges associated with the worker at the platform.

5. The method of claim 1, wherein the digital badge database is a distributed ledger network, and wherein identifying the one or more entries of the digital badge database that are associated with the team comprises:
transmitting, to one or more nodes of the distributed ledger network, a request for data indicating one or more digital badges issued to the team; and
receiving the data indicating the one or more digital badges issued to the team from at least one of the one or more nodes of the distributed ledger network in response to the request.

6. The method of claim 5, wherein the distributed ledger network is a blockchain network.

7. The method of claim 1, further comprising:
identifying data associated with actions performed by the workers of the team, wherein the data is identified from a plurality of data sources associated with at least one of the workers of the team or the organization;
providing the identified data as input to a machine learning model, wherein the machine learning model is trained to predict, based on given input indicating actions of workers, a benefaction level associated with the workers relative to other workers of the organization;
obtaining one or more outputs of the machine learning model, wherein the one or more outputs indicate a respective benefaction level for the workers of the team relative to other workers of the organization; and
responsive to determining that the respective benefaction level for the workers of the team satisfies one or more criteria associated with a goal defined by at least one of the team or the organization, updating the digital badge database to indicate that one or more digital badges are issued to the team.

8. The method of claim 7, wherein the machine learning model is a neural network.

9. The method of claim 7, further comprising:
responsive to updating the digital badge database to indicate that the one or more digital badges are issued to the team, removing the data associated with the actions performed by the workers of the team from at least one of the plurality of data sources.

10. A system comprising:
a memory; and
a processing device coupled to the memory, the processing device to perform operations comprising:
receiving a request for one or more digital badges associated with a particular worker of a plurality of workers of an organization;
determining a team of the organization associated with the particular worker during a tenure of the particular worker at the organization;
identifying one or more entries of a digital badge database that are associated with the team, wherein the one or more entries indicate one or more digital badges issued to the team based on a benefaction level determined for workers of the team;
extracting, and from the identified one or more entries associated with the team, a set of digital badges issued to the team during a time period that corresponds to a tenure of the particular worker; and
providing an indication of the extracted set of digital badges in response to the request.

11. The system of claim 10, wherein the request is received from an application that hosts a profile associated with the particular worker, wherein users of the application can access information associated with the particular worker via the profile.

12. The system of claim 11, wherein the application hosting the profile associated with the particular worker is associated with at least one of the organization or a social media platform.

13. The system of claim 11, wherein the operations further comprise:
responsive to receiving the request from the application, incrementing a counter associated with the profile associated with the particular worker, wherein the counter indicates a number of requests from the application for the one or more digital badges associated with the particular worker; and
determining, based on a value of the incremented counter, whether the maintain the one or more digital badges associated with the worker at the platform.

14. The system of claim 10, wherein the digital badge database is a distributed ledger network, and wherein identifying the one or more entries of the digital badge database that are associated with the team comprises:
transmitting, to one or more nodes of the distributed ledger network, a request for data indicating one or more digital badges issued to the team; and
receiving the data indicating the one or more digital badges issued to the team from at least one of the one or more nodes of the distributed ledger network in response to the request.

15. The system of claim 14, wherein the distributed ledger network is a blockchain network.

16. The system of claim 10, wherein the operations further comprise:
identifying data associated with actions performed by the workers of the team, wherein the data is identified from a plurality of data sources associated with at least one of the workers of the team or the organization;
providing the identified data as input to a machine learning model, wherein the machine learning model is trained to predict, based on given input indicating actions of workers, a benefaction level associated with the workers relative to other workers of the organization;
obtaining one or more outputs of the machine learning model, wherein the one or more outputs indicate a respective benefaction level for the workers of the team relative to other workers of the organization; and
responsive to determining that the respective benefaction level for the workers of the team satisfies one or more criteria associated with a goal defined by at least one of the team or the organization, updating the digital badge database to indicate that one or more digital badges are issued to the team.

17. The system of claim 16, wherein the machine learning model is a neural network.

18. A non-transitory computer readable medium comprising instructions that, when executed by a processing device, cause the processing device to perform operations comprising:
receiving a request for one or more digital badges associated with a particular worker of a plurality of workers of an organization;
determining a team of the organization associated with the particular worker during a tenure of the particular worker at the organization;
identifying one or more entries of a digital badge database that are associated with the team, wherein the one or more entries indicate one or more digital badges issued to the team based on a benefaction level determined for workers of the team;
extracting, and from the identified one or more entries associated with the team, a set of digital badges issued to the team during a time period that corresponds to a tenure of the particular worker; and
providing an indication of the extracted set of digital badges in response to the request.

19. The non-transitory computer readable medium of claim 18, wherein the request is received from an application that hosts a profile associated with the particular worker, wherein users of the application can access information associated with the particular worker via the profile.

20. The non-transitory computer readable medium of claim 19, wherein the application hosting the profile associated with the particular worker is associated with at least one of the organization or a social media platform.
